(19) United States
(12) Patent Application Publication
(10) Pub. No.: US 2026/0361219 A1
(43) Pub. Date: Nov. 12, 2026

(54) POWER CONVERTER WITH ANALOG DEAD TIME CONTROLLER

(71) Applicant: TEXAS INSTRUMENTS INCORPORATED, Dallas, TX (US)

(72) Inventors: Divya Kaur, Delhi (IN); Kevin Scoones, San Jose, CA (US)

(21) Appl. No.: 19/668,082

(22) Filed: May 5, 2026

Related U.S. Application Data
(63) Continuation-in-part of application No. 19/429,635, filed on Dec. 22, 2025.
(60) Provisional application No. 63/801,245, filed on May 7, 2025.

(51) Int. Cl. H02M 3/158; H02M 1/00; H02M 1/38

(52) U.S. Cl. CPC H02M 3/1582; H02M 1/0019; H02M 1/38

(57) ABSTRACT

An apparatus comprises a power stage, driver circuitry, and control circuitry. The power stage includes a first transistor having a current terminal and a control terminal; and a second transistor having a control terminal, and a current terminal coupled to the current terminal of the first transistor. The driver circuitry has an input, a first output, and a second output, the first output of the driver circuitry coupled to the control terminal of the first transistor, the second output of the driver circuitry coupled to the control terminal of the second transistor. The control circuitry is coupled to the driver circuitry and is configurable to adjust a dead time of the power stage responsive to a transient in a current conducted by the power stage exceeding a threshold.

### CROSS-REFERENCE TO RELATED APPLICATION

This patent application is a continuation-in-part of U.S. patent application Ser. No. 19/429,635, filed Dec. 22, 2025, entitled “Power Converter With Analog Dead Time Controller,” which claims the benefit of and priority to U.S. Provisional Patent Application No. 63/801,245 filed May 7, 2025, entitled “Cycle By Cycle, Load-Tracking Analog Dead Time Controller,” both of which are hereby incorporated by reference in their entireties.

### TECHNICAL FIELD

This description relates generally to power converters and, more particularly, to methods and apparatus to adjust dead time during switching using characteristics of a supply of power to a load.

### BACKGROUND

Power converters receive an input voltage and produce an output voltage. Boost converters produce an output voltage higher than their input voltage. Buck converters produce an output voltage lower than their input voltage. Buck-boost converters are capable of producing output voltages that are either higher or lower than their input voltage.

A switching converter uses switching operations across a series of switching cycles to regulate a supply of power from the input to generate the voltage at the output. During a first portion of a switching cycle, a first transistor supplies current to charge an inductor and capacitor, which sets the voltage at the output. During a second portion of the switching cycle, a second transistor sinks excess charge from the inductor and capacitor. A controller uses characteristics of the transistors, the inductor, and/or the capacitor and a target voltage of the output to determine timing of the first and second portions of the switching cycle. The switching converter provides power to a load at the target voltage responsive to driving the inductor and capacitor across multiple switching cycles.

### SUMMARY

In some examples, an apparatus includes an integrator having an output; first delay circuitry having an input and an output, the input of the first delay circuitry coupled to the output of the integrator; and second delay circuitry coupled to the first delay circuitry, the second delay circuitry including: a first current source having a terminal; a first transistor having a current terminal and a control terminal, the control terminal of the first transistor coupled to the output of the first delay circuitry; a second transistor having a first current terminal, a second current terminal, and a control terminal; a second current source having a terminal coupled to the first current terminal of the second transistor; and a third transistor having a current terminal and a control terminal, the current terminal of the third transistor coupled to the second current terminal of the second transistor, the control terminal of the third transistor coupled to the current terminal of the first transistor, the terminal of the first current source, and the control terminal of the second transistor. Other examples are described.

In some examples, an apparatus includes pulse width modulation (PWM) generation circuitry capable of generating a PWM signal, the PWM signal having a duty cycle; first delay circuitry capable of delaying an edge of the PWM signal responsive to a voltage signal; and second delay circuitry coupled to the first delay circuitry, the second delay circuitry capable of further delaying the edge of the PWM signal responsive to a current signal. Other examples are described.

In some examples, an apparatus comprises a power stage, driver circuitry, and control circuitry. The power stage includes a first transistor having a current terminal and a control terminal; and a second transistor having a control terminal, and a current terminal coupled to the current terminal of the first transistor. The driver circuitry has an input, a first output, and a second output, the first output of the driver circuitry coupled to the control terminal of the first transistor, the second output of the driver circuitry coupled to the control terminal of the second transistor. The control circuitry is coupled to the driver circuitry and is configurable to adjust a dead time of the power stage responsive to a transient in a current conducted by the power stage exceeding a threshold. Other examples are described.

### BRIEF DESCRIPTION OF THE DRAWINGS

FIG. 1 is a block diagram of an example power supply system including an example power converter.

FIG. 2 is a schematic diagram of an example of the power converter of FIG. 1 including a power stage and a controller having analog dead time reduction (ADTR) circuitry.

FIG. 3 is a block diagram of an example of the ADTR circuitry of FIG. 2 including an integrator, load transient detection circuitry, common mode voltage circuitry, and delay circuitry.

FIG. 4 is a schematic diagram of examples of the integrator and common mode voltage circuitry of FIG. 3.

FIGS. 5A, 5B, 5C, and 5D are schematic diagrams of examples of the load transient detection circuitry of FIG. 3.

FIG. 6 is a schematic diagram of an example of the delay circuitry of FIG. 3.

FIG. 7 is a timing diagram of example operations of the ADTR circuitry of FIGS. 2 and 3.

FIG. 8 is a schematic diagram of another example of the power converter of FIG. 1 including multiple power stages.

FIG. 9 is a block diagram of another example of the ADTR circuitry of FIGS. 2 and 3 including power delivery network (PDN) delay circuitry for the multiple power stages of FIG. 8.

FIG. 10 is a schematic diagram of an example of the PDN delay circuitry of FIG. 9.

The drawings are not necessarily to scale. Generally, the same reference numbers in the drawing(s) and this description refer to the same or similar (functionally and/or structurally) features and/or parts. Although the drawings show regions with clean lines and boundaries, some or all of these lines and boundaries may be idealized. In reality, the boundaries or lines may be unobservable, blended or irregular.

### DETAILED DESCRIPTION

Power converters regulate a voltage at an input to generate a different voltage at an output. Boost converters increase the voltage at the input to produce a higher voltage at the output. Buck converters decrease the voltage at the input to produce a lower voltage at the output. Buck-boost converters are capable of increasing or decreasing the voltage at the input to produce the voltage at the output. A switching converter uses switching operations across a series of switching cycles to regulate a supply of power from the input to generate the voltage at the output. During a first portion of a switching cycle, a first transistor (also referred to as a high-side field effect transistor (HS FET)) supplies current to charge an inductor and capacitor, which sets the voltage at the output. During a second portion of the switching cycle, a second transistor (also referred to as a low-side field effect transistor (LS FET)) sinks excess charge not supplied to a load from the inductor and capacitor. The switching converter provides power to a load at the target voltage by driving the inductor and capacitor across multiple switching cycles.

In operation, a controller uses characteristics of the transistors, the inductor, and/or the capacitor and a target voltage of the output to determine timing of the first and second portions of the switching cycle. In a switching cycle, the controller begins the first portion by turning off the LS FET and turning on the HS FET. However, it may take time to set a gate of the HS FET to a voltage level to turn on the HS FET. A time between turning off the LS FET and the actual turning on the HS FET is referred to as dead time. During the dead time, relatively high-speed switching between discharging through the LS FET and the turning on the HS FET may forward bias the body diode of the LS FET. For example, after turning off the LS FET, the inductor resists the rapid change in current conduction by producing a negative voltage (e.g., a voltage less than a common potential such as ground) at the switching node in order to maintain the current flow. In such examples, the negative voltage at the switching node causes a body diode formed between the drain and source to be forward biased. When the body diode is forward biased and conducting during the dead time, the voltage drop and the current on the body diode cause power loss and thus reduced efficiency, the output voltage may have higher ripples, and the converter may have a poor transient response. In addition, the forward biased body diode allows the inductor to continue to discharge, which may increase the time taken to turn on the HS FET.

Examples described herein include methods and apparatus to adjust dead time switching using characteristics of a power supply. In some described examples, a power converter includes analog dead time reduction (ADTR) circuitry. The ADTR circuitry delays the turn off the LS FET by a dynamic delay to give the HS FET time to turn on. The dynamic delay of the ADTR circuitry is a function of a supply of power to a load. For example, as a load current or voltage at the output increases, the ADTR circuitry adjusts the dynamic delay to further delay turning off the LS FET. Advantageously, increasing the turn off delay of the LS FET responsive to changes in the power supplied to the load reduces the dead time between turning off the LS FET and turning on the HS FET reduces reverse recovery charge and improves performance.

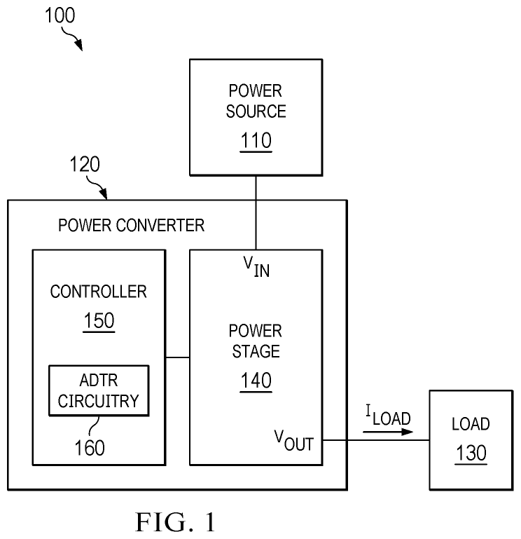

FIG. 1 is a block diagram of an example power supply system 100. In the example of FIG. 1, the power supply system 100 includes a power source 110, and a power converter 120. The power supply system 100 uses power from the power source 110 to power a load 130. Although in the example of FIG. 1, the load 130 is illustrated and described in connection with the power supply system 100, in other examples, the load 130 may be external to the power supply system 100. In some examples, the power supply system 100 is a distributed system having the power source 110 at a first location and the load 130 at a second location.

The power source 110 is coupled to the power converter 120. The power source 110 supplies power to the power converter 120. In some examples, the power source 110 is a power storage device, such as a battery. In another example, the power source 110 is a grid connection, which provides power from a power grid. In yet another example, the power source 110 is an additional power converter that regulates power for the power converter 120. The power source 110 provides a voltage (V_{IN}) to the power converter 120.

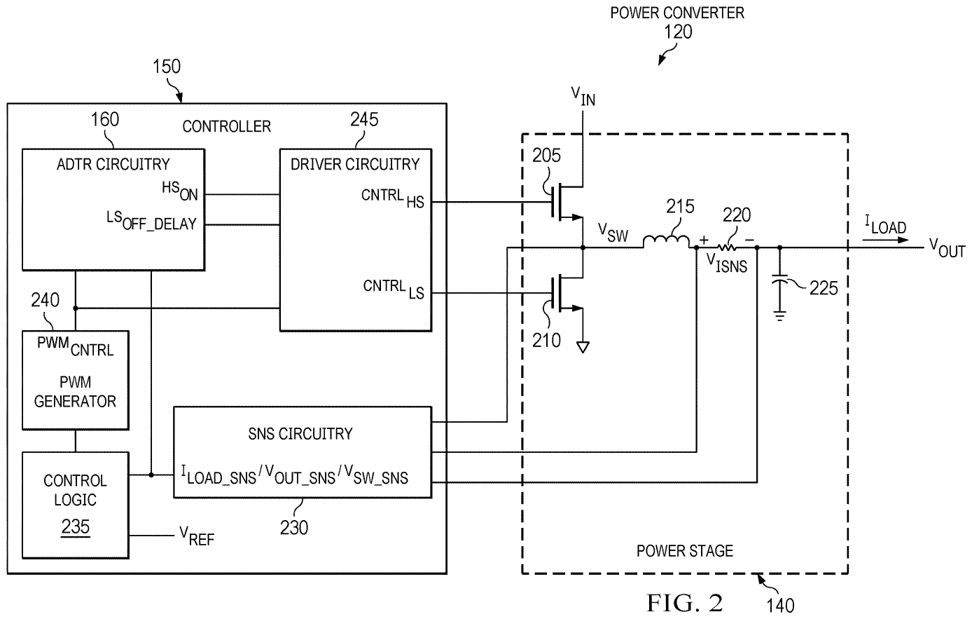

The power converter 120 is coupled between the power source 110 and the load 130. The power converter 120 of FIG. 1 includes a power stage 140, a controller 150, and analog dead time reduction (ADTR) circuitry 160. The power converter 120 regulates power from the power source 110 to deliver power the load 130. In operation, the power stage 140 generates a voltage (V_{OUT}) and current (I_{LOAD}) at an output responsive to the voltage (V_{IN}) from the power source 110 and signals from the controller 150. In some examples, the controller 150 provides a first signal, which controls the charging of the power stage 140 to increase the voltage (V_{OUT}) at the output. In such examples, the controller 150 provides a second signal, which controls the discharging of the power stage 140 to decrease the voltage (V_{OUT}) at the output and power supplied to a load. In such example operations, the ADTR circuitry 160 modifies timing of the signals from the controller 150 to reduce dead time between discharging and charging of the power stage 140. Examples of the power stage 140, the controller 150, and the ADTR circuitry 160 are further illustrated and described in connection with FIG. 2.

The load 130 is coupled to the power converter 120. The load 130 receives power from the power converter 120. The power received by the load 130 is a function of the voltage (V_{OUT}) and the current (I_{LOAD}). In operation, the power converter 120 may adjust the current (I_{LOAD}) responsive to changes in the power consumed by the load 130. For example, if the load 130 is a processor, the load 130 consumes additional power during processing operations in comparison to during idle conditions. In such examples, the power converter 120 adjusts one of the voltage (V_{OUT}) or current (I_{LOAD}) to account for the changes in power consumption by the load 130. In some examples, the power converter 120 is a multi-phase power converter, and the load 130 is a processor, such as a graphical processing unit (GPU), a central processing unit (CPU), etc. The processor's power demand may vary substantially with time due to varying workload, leading to substantial load current transients.

FIG. 2 is a schematic diagram of an example of the power converter 120 of FIG. 1. In the example of FIG. 2, the power converter 120 includes the power stage 140 and the controller 150. The power converter 120 receives a voltage (V_{IN}) from a power supply, such as the power supply 110. The power converter 120 provides a voltage (V_{OUT}) and current (I_{LOAD}) to power a load, such as the load 130. In operation, the power converter 120 charges and discharges the power stage 140 to provide a target voltage at the output. In such operations, the controller 150 adjusts the charging and discharging of the power stage 140 to maintain the voltage (V_{OUT}) at the output of the power converter 120 despite changes in the current (I_{LOAD}). The I_{LOAD} current can be provided by, for example, measuring the current conducted by transistors 205, 210, or inductor 215, to generate a sensed signal I_{LOAD_SNS}, or can be provided by the load 130. For example, a processor as part of the load 130 can provide a signal indicating a current demand.

The power stage 140 is coupled to the controller 150 and is structured to be coupled to the power supply 110 and the load 130. The power stage 140 of FIG. 2 includes transistors 205, 210, an inductor 215, a resistor 220, and a capacitor 225. The power stage 140 receives the voltage (V_{IN}) and control signals (e.g., CNTRL_{HS}, CNTRL_{LS}). The control signals (CNTRL_{HS}, CNTRL_{LS}) control respective ones of the transistors 205, 210. In the illustrated example, transistors 205 and 210 are n-channel transistors. If the control signals (CNTRL_{HS}, CNTRL_{LS}) are set (e.g., asserted, logical high, logic one, etc.), the corresponding one of the transistors 205, 210 conducts current to charge or discharge the inductor 215 and the capacitor 225. For example, the transistor 205 conducts current to charge the inductor 215 and the capacitor 225 responsive to the control signal (CNTRL_{HS}). Alternatively, the transistor 210 conducts current to discharge the inductor 215 and the capacitor 225 responsive to the control signal (CNTRL_{LS}). In some examples, the transistor 205 is referred to as a high-side (HS) field effect transistor (FET) and the transistor 210 is referred to as a low-side (LS) FET.

In operation, the inductor 215 and the capacitor 225 accumulate charge responsive to current from the transistor 205. The accumulated charge of the capacitor 225 sets the voltage (V_{OUT}). When the transistor 205 is conducting, the voltage (V_{OUT}) ramps up (e.g., increases) as the capacitor 225 charges. The inductor 215 and the capacitor 225 use the accumulated charge to provide the current (I_{LOAD}) or, more generally, supply power. In such operations, the transistor 210 sinks current to discharge excess accumulated charge from the inductor 215 and the capacitor 225. When the transistor 210 is conducting, the voltage (V_{OUT}) ramps down (e.g., decreases) as the capacitor 225 discharges. In some examples, the rate of discharge of the capacitor 225 is a function of the current (I_{LOAD}).

In some examples, such as in FIG. 2, the power stage 140 produces a node voltage (V_{SW}), a sense voltage (V_{ISNS}), and the supply voltage (V_{OUT}). The transistors 205, 210 generate the node voltage (V_{SW}) responsive to the charge and discharge of the inductor 215. In some examples, the node voltage (V_{SW}) represents the drain-to-source voltage of the transistor 210. The resistor 220 generates the sense voltage (V_{ISNS}) as a function of a resistance and the load current (I_{LOAD}). In some examples, the resistor 220 is referred to as an in-line current sensor. The capacitor 225 generates the supply voltage (V_{OUT}) using current from the inductor 215. In operation, the power stage 140 provides the node voltage (V_{SW}), the sense voltage (V_{ISNS}), and the supply voltage (V_{OUT}) to the controller 150.

The controller 150 is coupled to the power stage 140. The controller 150 of FIG. 2 includes ADTR circuitry 160, sense circuitry 230, control logic 235, pulse width modulation (PWM) generation circuitry 240, and driver circuitry 245. The controller 150 receives the node voltage (V_{SW}), the sense voltage (V_{ISNS}), and the supply voltage (V_{OUT}). The controller 150 generates the control signals (CNTRL_{HS}, CNTRL_{LS}) using the node voltage (V_{SW}), the sense voltage (V_{ISNS}), and the supply voltage (V_{OUT}).

The sense circuitry 230 receives the node voltage (V_{SW}), the sense voltage (V_{ISNS}), and the supply voltage (V_{OUT}) from the power stage 140. The sense circuitry 230 divides the sense voltage (V_{ISNS}) by a resistance of the resistor 220 to determine the load current (I_{LOAD}). In some examples, the sense circuitry 230 scales the node voltage (V_{SW}), the supply voltage (V_{OUT}), and the load current (I_{LOAD}) to generate signals in a power domain of the controller 150. The sense circuitry 230 generates a sensed node voltage (V_{SW_SNS}), a sensed load current (I_{LOAD_SNS}), and a sensed supply voltage (V_{OUT_SNS}) as representatives of the node voltage (V_{SW}), the supply voltage (V_{OUT}), and the load current (I_{LOAD}). The sense circuitry 230 provides one or more of the sensed node voltage (V_{SW_SNS}), the sensed load current (I_{LOAD_SNS}), and the sensed supply voltage (V_{OUT_SNS}) to the control logic 235 and the ADTR circuitry 160.

The control logic 235 receives the sensed supply voltage (V_{OUT_SNS}) and a reference voltage (VREF). The reference voltage (VREF) represents a target voltage of the supply voltage (V_{OUT}). In some examples, the reference voltage (VREF) is scaled to match the scaling of the sense circuitry 230 to the supply voltage (V_{OUT}). The control logic 235 compares the sensed supply voltage (V_{OUT_SNS}) to the reference voltage (VREF).

The PWM generation circuitry 240 generates a falling edge on a PWM control signal (PWM_{CNTRL}) responsive to the control logic 235 determining that the sensed supply voltage (V_{OUT_SNS}) is greater than the reference voltage (VREF). The PWM control signal (PWM_{CNTRL}) is a PWM signal or, more generally, a square wave having a duty cycle set by the control logic 235. The PWM control signal (PWM_{CNTRL}) represents switching operations of the transistors 205, 210. In some examples, setting the PWM control signal (PWM_{CNTRL}) to a logical high corresponds to the transistor 205 conducting and the transistor 210 not conducting. Alternatively, setting the PWM control signal (PWM_{CNTRL}) to a logical low corresponds to the transistor 205 not conducting current and the transistor 210 conducting current.

In operation, the PWM generation circuitry 240 starts a switching cycle of the power converter 120 by generating a rising edge on the PWM control signal (PWM_{CNTRL}). The PWM generation circuitry 240 generates a falling edge on the PWM control signal (PWM_{CNTRL}) responsive to the control logic 235 determining that the sensed supply voltage (V_{OUT_SNS}) is greater than the reference voltage (VREF). The PWM generation circuitry 240 keeps the PWM control signal (PWM_{CNTRL}) deasserted for the remainder of the switching cycle. In such operations, the duration of the switching cycle is set by a switching frequency. Such example operations of the control logic 235 and the PWM generation circuitry 240 implement a fixed switching frequency. Alternatively, in other examples, the control logic 235 and the PWM generation circuitry 240 may implement a variable switching frequency. For example, the PWM generation circuitry 240 generates a subsequent rising edge responsive to the control logic 235 determining that the sensed supply voltage (V_{OUT_SNS}) is less than a second reference voltage. In both examples, the PWM generation circuitry 240 provides the PWM control signal (PWM_{CNTRL}) to the ADTR circuitry 160 and the driver circuitry 245.

The ADTR circuitry 160 is coupled to the sense circuitry 230, the PWM generation circuitry 240, and the driver circuitry 245. The ADTR circuitry 160 generates a high-side turn on signal (HS_{ON}) and a delayed low-side turn off signal (LS_{OFF_DELAY}) using the sensed node voltage (V_{SW_SNS}), the sensed load current (I_{LOAD_SNS}), the sensed supply voltage (V_{OUT_SNS}), and the PWM control signal (PWM_{CNTRL}). The high-side turn on signal (HS_{ON}) represents turn on operations of the transistor 205. The ADTR circuitry 160 generates a rising edge on the high-side turn on signal (HS_{ON}) responsive to a rising edge of the PWM control signal (PWM_{CNTRL}). The delayed low-side turn off signal (LS_{OFF_DELAY}) represents turn off operations of the transistor 210. The ADTR circuitry 160 generates a rising edge on the delayed low-side turn off signal (LS_{OFF_DELAY}) responsive to a rising edge of the PWM control signal (PWM_{CNTRL}). However, unlike the high-side turn on signal (HS_{ON}), the ADTR circuitry 160 delays the generation of rising edges of the delayed low-side turn off signal (LS_{OFF_DELAY}) by a delay. The ADTR circuitry 160 sets the delay of the delayed low-side turn off signal (LS_{OFF_DELAY}) using the sensed node voltage (V_{SW_SNS}), the sensed load current (I_{LOAD_SNS}), and the sensed supply voltage (V_{OUT_SNS}).

In operation, the ADTR circuitry 160 adjusts the delay of rising edges of the delayed low-side turn off signal (LS_{OFF_DELAY}) as the sensed node voltage (V_{SW_SNS}), the sensed load current (I_{LOAD_SNS}), and/or the sensed supply voltage (V_{OUT_SNS}) change. The ADTR circuitry 160 uses the delayed low-side turn off signal (LS_{OFF_DELAY}) to delay turning off the transistor 210 until the transistor 205 is ready to turn on. For example, the delay of the ADTR circuitry 160 corresponds to the time the driver circuitry 245 needs to charge a control terminal of the transistor 205 to a threshold voltage greater than the node voltage (V_{SW}), where the charge may be a function of the sensed node voltage (V_{SW_SNS}), the sensed load current (I_{LOAD_SNS}), and the sensed supply voltage (V_{OUT_SNS}).

The driver circuitry 245 is coupled to the ADTR circuitry 160, the transistors 205, 210, and the PWM generation circuitry 240. The driver circuitry 245 determines a high-side turn off signal (HS_{OFF}) and a low-side turn on signal (LS_{ON}) using the PWM control signal (PWM_{CNTRL}). The high-side turn off signal (HS_{OFF}) represents turn off operations of the transistor 205. The low-side turn on signal (LS_{ON}) represents turn on operations of the transistor 210. In operation, the driver circuitry 245 determines to turn off the transistor 205 and turn on the transistor 210 responsive to a falling edge of the PWM control signal (PWM_{CNTRL}).

The driver circuitry 245 controls the transistors 205, 210 by generating the control signals (CNTRL_{HS}, CNTRL_{LS}). The driver circuitry 245 sets the control signal (CNTRL_{HS}) responsive to a rising edge of the high-side turn on signal (HS_{ON}). Alternatively, the driver circuitry 245 clears the control signal (CNTRL_{HS}) responsive to a rising edge of the high-side turn off signal (HS_{OFF}) or, more generally, a falling edge of the PWM control signal (PWM_{CNTRL}). Similarly, the driver circuitry 245 sets the control signal (CNTRL_{LS}) responsive to a rising edge of the low-side turn on signal (LS_{ON}) or, more generally, a falling edge of the PWM control signal (PWM_{CNTRL}). Alternatively, the driver circuitry 245 clears the control signal (CNTRL_{LS}) responsive to a rising edge of the delayed low-side turn off signal (LS_{OFF_DELAY}) from the ADTR circuitry 160. The driver circuitry 245 provides the control signals (CNTRL_{HS}, CNTRL_{LS}) to the power stage 140.

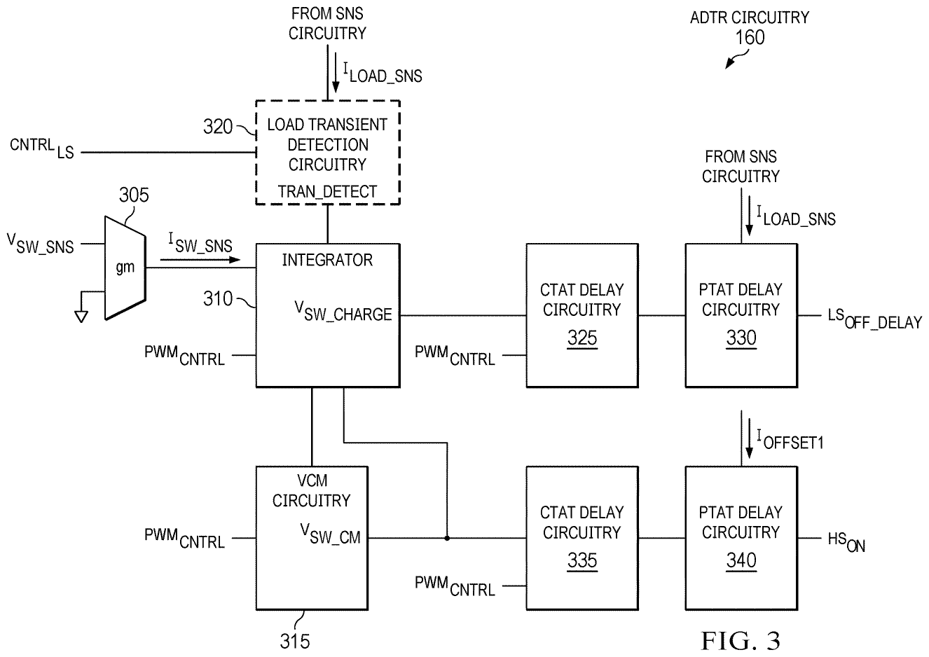

Advantageously, the ADTR circuitry 160 reduces the time between the transistor 205 conducting and the transistor 210 conducting by delaying the turn off of the transistor 210 until the transistor 210 is ready to conduct. Such time is referred to as the dead time. Advantageously, reducing dead time of the power stage 140 improves performance and reduces the reverse recovery charge of the transistors 205, 210 and reduces power loss. Advantageously, the ADTR circuitry 160 adjusts the delay by tracking changes in the sensed node voltage (V_{SW_SNS}), the sensed load current (I_{LOAD_SNS}), and the sensed supply voltage (V_{OUT_SNS}). Example operations of the ADTR circuitry 160 are further described in connection with FIGS. 3, 4, 5, and 6.

FIG. 3 is a block diagram of an example of the ADTR circuitry 160 of FIGS. 1 and 2. In the example of FIG. 3, the ADTR circuitry 160 includes a transconductance amplifier 305, an integrator 310, common mode voltage circuitry 315, load transient detection circuitry 320, and delay circuitry 325, 330, 335, 340. The ADTR circuitry 160 receives the sensed node voltage (V_{SW_SNS}), the sensed load current (I_{LOAD_SNS}), the sensed supply voltage (V_{OUT_SNS}), the PWM control signal (PWM_{CNTRL}), and the control signal (CNTRL_{LS}). The ADTR circuitry 160 generates the high-side turn on signal (HS_{ON}) responsive to rising edges of the PWM control signal (PWM_{CNTRL}). The ADTR circuitry 160 delays edges of the delayed low-side turn off signal (LS_{OFF_DELAY}) responsive to rising edges of the PWM control signal (PWM_{CNTRL}). The ADTR circuitry 160 sets the delay of the delayed low-side turn off signal (LS_{OFF_DELAY}) using the sensed node voltage (V_{SW_SNS}), the sensed load current (I_{LOAD_SNS}), and the sensed supply voltage (V_{OUT_SNS}). In some examples, the ADTR circuitry 160 also uses the control signal (CNTRL_{LS}) to set the delay of the delayed low-side turn off signal (LS_{OFF_DELAY}). The ADTR circuitry 160 provides the high-side turn on signal (HS_{ON}) and the delayed low-side turn off signal (LS_{OFF_DELAY}) to the driver circuitry 245.

The transconductance amplifier 305 is coupled to the integrator 310. The transconductance amplifier 305 compares the sensed node voltage (V_{SW_SNS}) to a common potential (e.g., ground, AVSS, zero volts, etc.). The transconductance amplifier 305 generates a node current (I_{SW_SNS}) to represent the comparison of the sensed node voltage (V_{SW_SNS}). In operation, the node current (I_{SW_SNS}) is a function of the node voltage (V_{SW}) of the power stage 140. In some examples, the transconductance amplifier 305 may be referred to as an amplifier, error circuitry, etc.

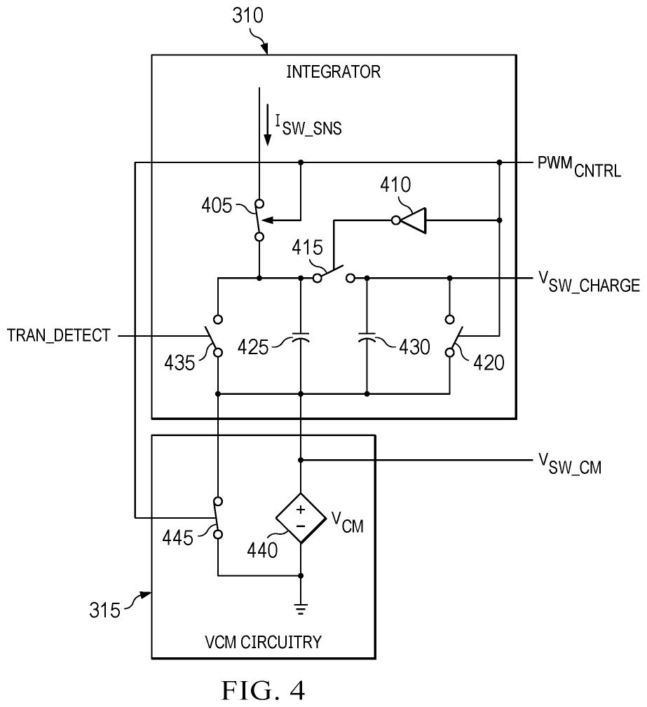

The integrator 310 is coupled to the transconductance amplifier 305, the common mode voltage circuitry 315, the load transient detection circuitry 320, and the delay circuitry 325. The integrator 310 receives the PWM control signal (PWM_{CNTRL}), the node current (I_{SW_SNS}), a common mode voltage (V_{SW_CM}), and a detection signal (TRAN_DETECT). The common mode voltage (V_{SW_CM}) is a fixed direct current (DC) offset voltage. The detection signal (TRAN_DETECT) represents detected relatively high-speed transients in the sensed load current (I_{LOAD_SNS}) or, more generally, the load current (I_{LOAD}). The integrator 310 generates a charge voltage (V_{SW_CHARGE}) representing a dead time of the power stage 140. In some examples, the integrator 310 integrates the node current (I_{SW_SNS}) between a rising edge of the PWM control signal (PWM_{CNTRL}) and when the transistors 205 actually turns on. An example implementation of the integrator 310 is further illustrated and described in connection with FIG. 4. Advantageously, the charge voltage (V_{SW_CHARGE}) is a function of the dead time of the power stage 140.

The common mode voltage circuitry 315 is coupled to the integrator 310 and the delay circuitry 335. The common mode voltage circuitry 315 generates the common mode voltage (V_{SW_CM}). In some examples, the common mode voltage circuitry 315 sets the common mode voltage (V_{SW_CM}) as an independently generated analog bias voltage. The common mode voltage circuitry 315 provides the common mode voltage (V_{SW_CM}) based on the PWM control signal (PWM_{CNTRL}). An example implementation of the common mode voltage circuitry 315 is further illustrated and described in connection with FIG. 4.

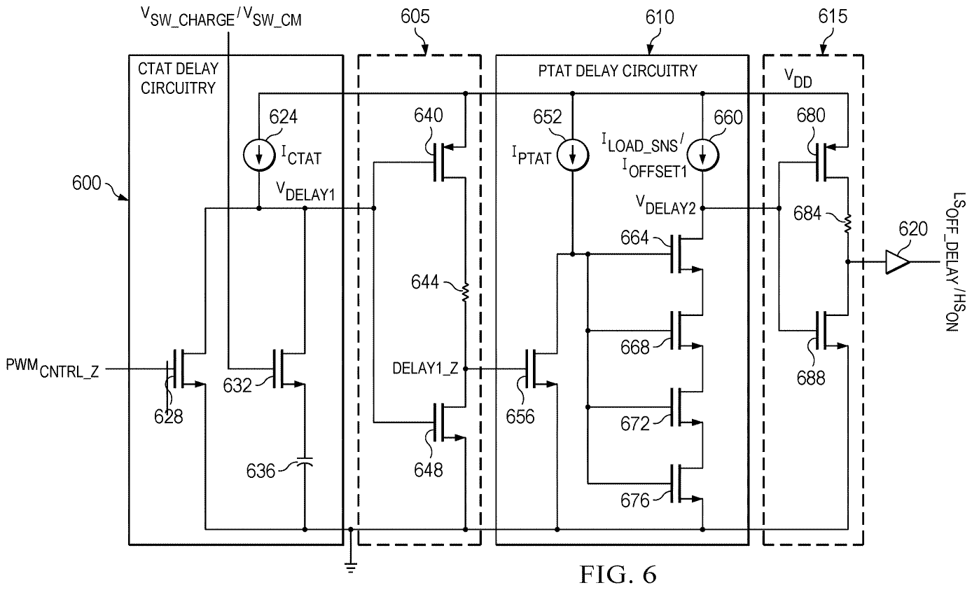

The delay circuitry 325 is coupled to the integrator 310 and the delay circuitry 330. The delay circuitry 325 receives the charge voltage (V_{SW_CHARGE}) and the PWM control signal (PWM_{CNTRL}). The delay circuitry 325 delays edges of the PWM control signal (PWM_{CNTRL}) by a delay that is a function of the charge voltage (V_{SW_CHARGE}), such that the V_{SW_CHARGE} adds to the delay in turning off of the low side transistor (e.g., the transistor 210) compared to the turning on of the high side transistor (e.g., the transistor 205). In operation, the delay of the delay circuitry 325 tracks changes in the sensed node voltage (V_{SW_SNS}) or, more generally, the node voltage (V_{SW}) using the charge voltage (V_{SW_CHARGE}) as a threshold. An example of the delay circuitry 325 is further illustrated and described in connection with FIG. 6.

The load transient detection circuitry 320 is coupled to the integrator 310. The load transient detection circuitry 320 receives the sensed load current (I_{LOAD_SNS}) and the control signal (CNTRL_{LS}). The load transient detection circuitry 320 monitors the sensed load current (I_{LOAD_SNS}) for relatively high-speed changes. For example, the load transient detection circuitry 320 detects transient load conditions responsive to a change in the sensed load current (I_{LOAD_SNS}) greater than a threshold between the transistor 210 turning on and off. In such examples, the load transient detection circuitry 320 uses the control signal (CNTRL_{LS}) to time the detection. The load transient detection circuitry 320 generates the detection signal (TRAN_DETECT) to represent the detection of transient load currents. The TRAN_DETECT signal provided by the load transient detection circuitry 320 can reset the integrator 310, such that the low side transistor 210 is turned off earlier, and the current for that cycle can be carried by the body diode of the low side transistor. Such arrangements enables quickly setting the dead time (e.g., by removing the delay introduced by the integrator) in response to a load step to reduce the likelihood of shoot through (or short circuit) in the event of a huge load transient.

The delay circuitry 330 is coupled to the delay circuitry 325. The delay circuitry 330 receives the sensed load current (I_{LOAD_SNS}) and the delayed PWM control signal from the delay circuitry 325. The delay circuitry 330 further delays edges of the PWM control signal (PWM_{CNTRL}) by a delay that is a function of the sensed load current (I_{LOAD_SNS}). In operation, the delay of the delay circuitry 330 tracks changes in the sensed load current (I_{LOAD_SNS}) or, more generally, the load current (I_{LOAD}). The delay circuitry 330 generates the delayed low-side turn off signal (LS_{OFF_DELAY}) using the delay that is a function of the sensed load current (I_{LOAD_SNS}).

The delay circuitry 335 is coupled to the common mode voltage circuitry 315 and the delay circuitry 340. The delay circuitry 335 receives the common mode voltage (V_{SW_CM}) and the PWM control signal (PWM_{CNTRL}). The delay circuitry 335 delays edges of the PWM control signal (PWM_{CNTRL}) by a delay that is a function of the common mode voltage (V_{SW_CM}). In operation, the delay of the delay circuitry 335 tracks changes in the common mode voltage (V_{SW_CM}). An example of the delay circuitry 335 is further illustrated and described in connection with FIG. 6.

The delay circuitry 340 is coupled to the delay circuitry 335. The delay circuitry 340 receives an offset current (I_{OFFSET1}) and the delayed PWM control signal from the delay circuitry 335. The delay circuitry 340 further delays edges of the PWM control signal (PWM_{CNTRL}) by a delay that is a function of the offset current (I_{OFFSET1}). In some examples, the offset current (I_{OFFSET1}) represents differences between a first signal path formed by the delay circuitry 325, 330 for the delayed low-side turn off signal (LS_{OFF_DELAY}) and a second signal path formed by the delay circuitry 335, 340, and can be a feedforward replica to cancel or at least mitigate the delay difference between the two signal paths. In other examples, the offset current (I_{OFFSET1}) is a component of the sensed load current (I_{LOAD_SNS}). For example, the offset current (I_{OFFSET1}) is the DC component of the sensed load current (I_{LOAD_SNS}).

In operation, the delays of the delay circuitry 335, 340 track delays of analog components forming the delay circuitry 325, 330. In some examples, analog delay of the delay circuitry 325 may be set to compensate the complementary to absolute temperature (CTAT) behavior of the body diode (not illustrated) of the transistor 210. In such operations, the operation of the delay circuitry 325 may track the operations of the body diode of the transistor 210. In some examples, analog delay of the delay circuitry 330 may track and compensate the proportional to absolute temperature (PTAT) behavior of the driver turn-on time. For example, the delay circuitry 330 may delay the low-side turn off signal (LS_{OFF_DELAY}) in a manner to compensate the PTAT behavior of the driver turn-on time. The delay circuitry 335, 340 generate the high-side turn on signal (HS_{ON}) by a delay that accounts for component delays of the delay circuitry 325, 330 in the delayed low-side turn off signal (LS_{OFF_DELAY}).

In operation, the turn on time of the transistor 205 changes with the node voltage (V_{SW}) and the load current (I_{LOAD}). For example, as the node voltage (V_{SW}) and the load current (I_{LOAD}) increase, the time the driver circuitry 245 takes to set the control terminal of the transistor 205 to a gate voltage capable of turning on the transistor 205 increases. Advantageously, the delay circuitry 325, 330 delays turning off the transistor 210 by a delay that tracks changes in the node voltage (V_{SW}) and the load current (I_{LOAD}). For example, the transconductance amplifier 305, the integrator 310, and the delay circuitry 325 track the node voltage (V_{SW}) during a time period when the node voltage (V_{SW}) is below a common potential (e.g., negative). In such examples, the time the node voltage (V_{SW}) is below the common potential changes with the dead time. Advantageously, the delay in turning off the transistor 210 provides additional time for the driver circuitry 245 to turn on the transistor 205 without producing shoot through. Advantageously, the delay circuitry 325, 330 reduces dead time during switching by dynamically turning off the transistor 210 using characteristics of the power stage 140. Advantageously, the delay circuitry 335, 340 differentially accounts for unideal analog component delays, such as propagation delay, in the delay circuitry 325, 330. Advantageously, the delay of the high-side turn on signal (HS_{ON}) is a function of the propagation delays of the delay circuitry 325, 330. Example operations of the delay circuitry 325, 330, 335, 340 are further described in connection with FIG. 6.

FIG. 4 is a schematic diagram of example implementations of the integrator 310 and the common mode voltage circuitry 315. The integrator 310 receives the PWM control signal (PWM_{CNTRL}), the node current (I_{SW_SNS}), the common mode voltage (V_{SW_CM}), and the detection signal (TRAN_DETECT). In the example of FIG. 4, the integrator 310 includes a switch 405, an inverter 410, a switch 415, a switch 420, capacitors 425, 430, and a switch 435. The PWM control signal (PWM_{CNTRL}) controls the switches 405, 420, and 415. The inverter 410 inverts the PWM control signal (PWM_{CNTRL}) to control the switch 415. The capacitors 425, 430 generate the charge voltage (V_{SW_CHARGE}) by accumulating charge of the node current (I_{SW_SNS}). The switches 405, 415, 420 sequence charging and discharging of the capacitors 425, 430 responsive to edges of the PWM control signal (PWM_{CNTRL}).

In operation, the switches 405, 415 are controlled such that the capacitor 425 is charged using the node current (I_{SW_SNS}) between a rising edge and falling edge of the PWM control signal (PWM_{CNTRL}). Also, between the rising and falling edges of the PWM control signal (PWM_{CNTRL}), the switch 420 discharges the capacitor 430. During such time, a dead time occurs between the turn off of the transistor 210 and the turn on of the transistor 205. During the dead time, the inductor 215 pulls the node voltage (V_{SW}) below the common potential (e.g., ground) by forward biasing a body diode of the transistor 210 in an attempt to resist the change in current from the turning off of the transistor 210. If the node voltage (V_{SW}) is less than the common potential, the transconductance amplifier 305 sources the node current (I_{SW_SNS}), which charges the capacitor 425 to generate the charge voltage (V_{SW_CHARGE}). Once the transistor 205 begins to conduct current, the node voltage (V_{SW}) increases and the transconductance amplifier 305 stops supplying a current, which stops charging the capacitor 425. Advantageously, the charges accumulated by the capacitor 425 track the dead time of between the turn off of the transistor 210 and the turn on of the transistor 205.

Thereafter, the switches 405, 420 open and the switch 415 closes to couple the capacitors 425, 430 in parallel, such that charges may be redistributed between capacitors 425 and 430 and thus capacitors 425 and 430 may have the same voltage (V_{SW_CHARGE}), which may be lower than the voltage of capacitor 425 during the dead time due to the charge redistribution. Subsequently, the switch 415 may open to decouple the capacitors 425, 430. In some examples, the capacitors 425, 430 have capacitances to hold the charge voltage (V_{SW_CHARGE}) across one or more switching cycles. When the load transient detection circuitry 320 detects a transient in the load current (I_{LOAD}), the detection signal (TRAN_DETECT) closes the switch 435 to discharge capacitor 425 and/or capacitor 430. The closing of the switch 435 resets the charge voltage (V_{SW_CHARGE}) until a subsequent switching cycle. Advantageously, resetting the charge voltage (V_{SW_CHARGE}) reduces the delay of the delay circuitry 325 until the integrator 310 can determine a new dead time of the power stage 140.

The common mode voltage circuitry 315 is coupled to the integrator 310. The common mode voltage circuitry 315 receives the PWM control signal (PWM_{CNTRL}). In some examples, the PWM control signal (PWM_{CNTRL}) is a local signal that is derived from a global instance of the PWM control signal (PWM_{CNTRL}). For example, the PWM control signal (PWM_{CNTRL}) of FIG. 4 is digitally isolated from other components of the ADTR circuitry 160. The common mode voltage circuitry 315 of FIG. 4 includes a voltage source 440 and a switch 445. In operation, if the integrator 310 is charging the capacitor 425, the switch 445 sets the common mode voltage (V_{SW_CM}) to the common potential. After the integrator 310 has finished charging, the voltage source 440 sets the common mode voltage (V_{SW_CM}) as a DC voltage. In some examples, the common mode voltage (V_{SW_CM}) is the DC component of the node voltage (V_{SW}). At such time, the common mode voltage circuitry 315 offsets the charge voltage (V_{SW_CHARGE}) by the common mode voltage (V_{SW_CM}). Advantageously, the common mode voltage circuitry 315 offsets the charge voltage (V_{SW_CHARGE}) to account for DC offsets.

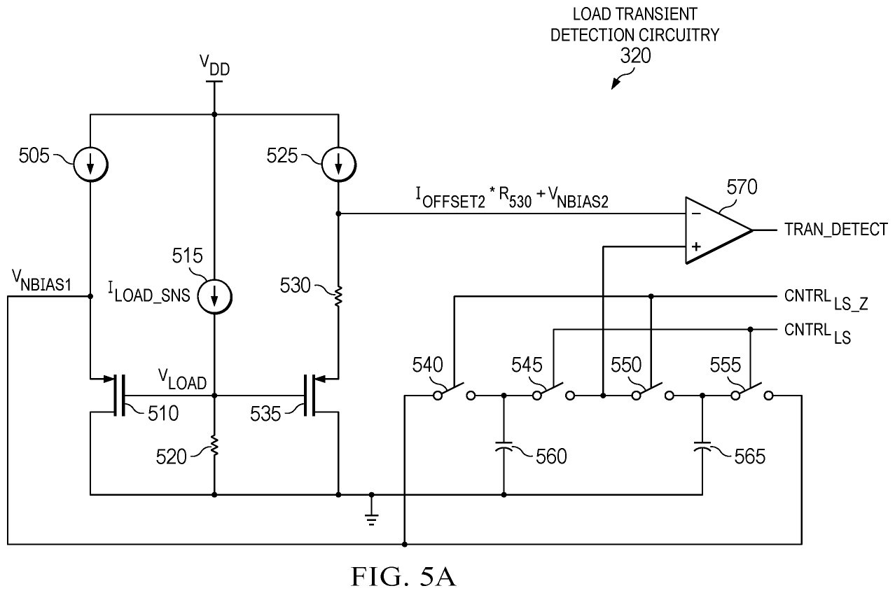

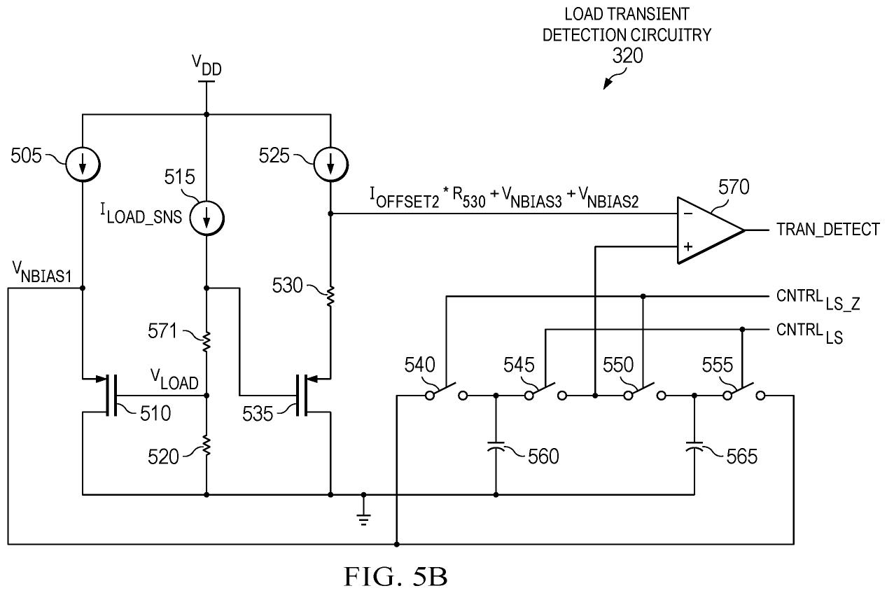

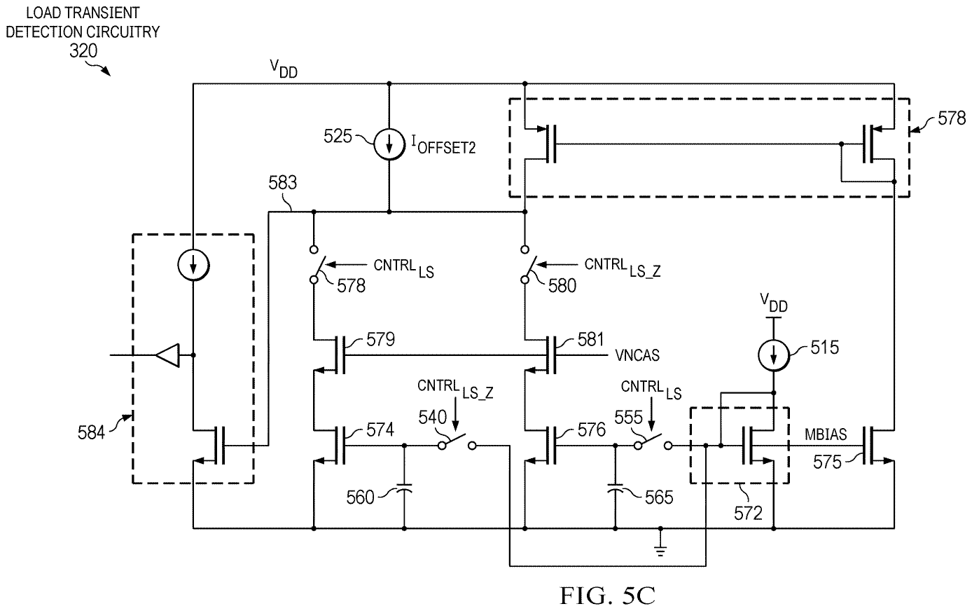

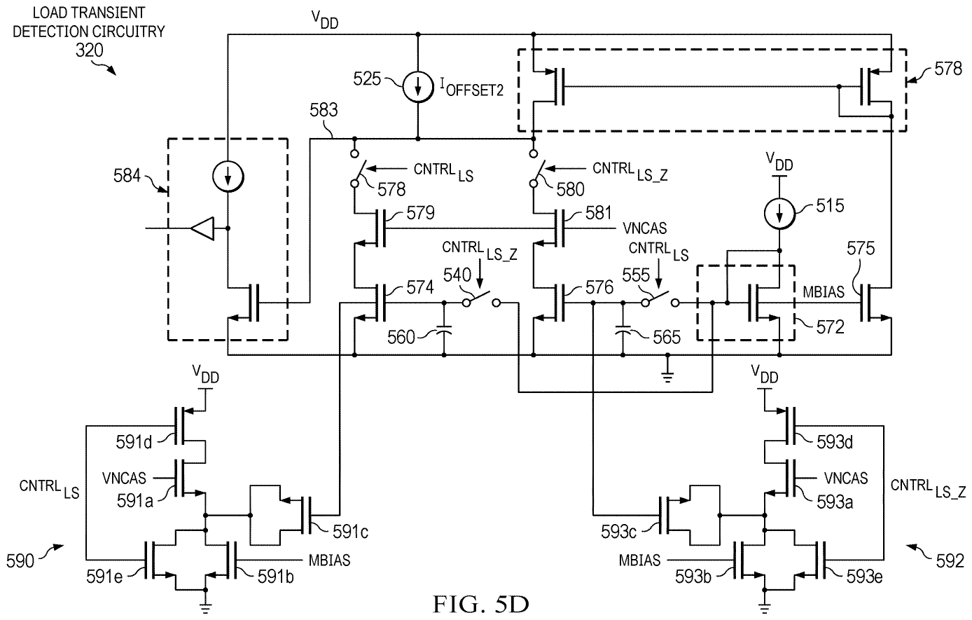

FIG. 5A is a schematic diagram of an example of the load transient detection circuitry 320. In the example of FIG. 5A, the load transient detection circuitry 320 includes a current source 505, a transistor 510, a current source 515, a resistor 520, a current source 525, a resistor 530, a transistor 535, switches 540, 545, 550, 555, capacitors 560, 565, and an amplifier 570. The load transient detection circuitry 320 receives the sensed load current (I_{LOAD_SNS}) from the current source 515, which can include a transistor having a control terminal (e.g., gate) driven by a current sensor that senses the load current I_{LOAD} at, for example, the transistors 205, 210, and/or inductor 215. The sensed load current (I_{LOAD_SNS}) may be a scaled representation of the load current (I_{LOAD}). The I_{LOAD_SNS} current passes through the resistor 520 to provide the reference load voltage (V_{LOAD}), which sets the gate voltages of the transistor 510 and 535. Also, each of the current sources 505 and 525 can provide a current, such as an offset current I_{OFFSET2}, to set a threshold for transient detection. The load transient detection circuitry 320 generates the detection signal (TRAN_DETECT) to represent transients in the load current (I_{LOAD}).

In operation, the current source 515 and the resistor 520 generate a reference load voltage (V_{LOAD}). The reference load voltage (V_{LOAD}) is a function of the sensed load current (I_{LOAD_SNS}) or, more generally, the load current (I_{LOAD}). The transistors 510, 535 conduct a current responsive to the reference load voltage (V_{LOAD}). The transistors 535 sinks a current from the current source 525 and the resistor 530 to generate a voltage being a sum of an offset voltage (V_{OFFSET}) and a variable component V_{NBIAS2}. The variable component V_{NBIAS2} is set by the voltage drop across the transistor 535. The offset voltage (V_{OFFSET}) can be a constant offset provided by resistor 530 and the I_{OFFSET2} current provided by the current source 525, and can be used as a threshold for generating the detection signal (TRAN_DETECT) to trigger the integrator reset of FIG. 3 to prevent shoot through, as described here.

The load transient detection circuitry 320 also receives the control signals CNTRL_{LS}. In operations, the switches 540, 555 are controlled so that the capacitors 560, 565 are charged using the voltage V_{NBIAS1} due to a difference between current from the current source 505 (I_{OFFSET2}) and the current of the transistor 510 (generated responsive to V_{LOAD}). If the control signals CNTRL_{LS} is asserted and CNTRL_{LS_Z} is de-asserted (e.g., the transistor 210 is conducting), the switch 545 is enabled and provides the voltage of the capacitor 560 to the amplifier 570. Also the switch 555 is enabled, and the capacitor 565 is charged through the switch 555. If the control signals CNTRL_{LS} is de-asserted and CNTRL_{LS_Z} is asserted (e.g., the transistor 210 is not conducting), the switch 550 is enabled and provides the voltage of the capacitor 565 to the amplifier 570. Also, the switch 540 is enabled, and the capacitor 560 is charged through the switch 540. The voltage of the capacitor 560 represents the load current (I_{LOAD}) when the transistor 210 is in the on state (conducting current). The voltage of the capacitor 565 represents the load current (I_{LOAD}) when the transistor 210 is in the off state (not conducting current).

Also, the amplifier 570 generates the detection signal (TRAN_DETECT) by comparing the voltages of the capacitors 560, 565 (e.g., V_{NBIAS2}) to the reference voltage (V_{NBIAS1}+V_{OFFSET}), which is analogous to comparing a difference between V_{NBIAS1} and V_{NBIAS2} (representing the load transient step) with the V_{OFFSET}, which represents a threshold in FIG. 5A for triggering the integrator reset.

For example, if the transistor 210 is in the off state, excess current of the current source 505 charges the capacitor 560 through the switch 540, and the resistor 530 generates a first reference voltage responsive to a first load current (I_{LOAD1}). If the transistor 210 is in the on state, the capacitor 565 is charged through the switch 555, and the resistor 530 generates a second reference voltage responsive to a second load current (I_{LOAD2}). At such time, the amplifier 570 compares the voltage of the capacitor 560, which has a voltage corresponding to the first load current (I_{LOAD1}), to the second reference voltage corresponding to the second load current (I_{LOAD2}). The amplifier 570 detects a transient as a change between the first and second load currents by comparing the offset voltage (V_{OFFSET}) with a voltage representing a difference between I_{LOAD1} and I_{LOAD2}.

Advantageously, the load transient detection circuitry 320 detects changes in the load current (I_{LOAD}) between turning on and off the transistor 210. Alternatively, the load transient detection circuitry 320 may detect changes in the load current (I_{LOAD}) between turning on and off the transistor 205.

FIG. 5B is a schematic diagram of an example of the load transient detection circuitry 320. In the example of FIG. 5B, the load transient detection circuitry 320 includes a resistor 572 coupled to a node between the current source 515 and the resistor 520, and the gate of the transistor 535 is coupled to the resistor 571, while the gate of the transistor 510 is coupled to a node between the resistors 520 and 571. With the arrangements of FIG. 5B, the reference voltage provided to the negative input of the amplifier 570 becomes I_{OFFSET2}*R₅₃₀+V_{Nbias3}+V_{NBias2}, where V_{NBias3} is a function of I_{LOAD_SNS} and R₅₇₁. Accordingly, the offset voltage (V_{OFFSET}) component of the reference voltage, which equals I_{OFFSET2}*R₅₃₀+V_{Nbias3}, becomes also a function of I_{LOAD_SNS}, making the offset voltage (and the threshold for triggering the integrator reset) a function of the load current. Such arrangements can reduce the likelihood of false triggering due to fluctuations in the load current. Accordingly, under heavy load condition with a large load current, the threshold can be adjusted upwards by making the threshold a function of the load current, so that the triggering (and the resulting integrator reset) occurs only when a sufficiently large load step (relative to the heavy load) occurs. On the other hand, when load current is small, the offset voltage (V_{OFFSET}) component can be mostly dominated by I_{OFFSET2} provided by the current source 525, and therefore the threshold can be largely constant and do not vary with the load current.

FIG. 5C is a schematic diagram of another example of the load transient detection circuitry 320. As shown in FIG. 5C, the current source 515, which provides the sensed load current I_{LOAD_SNS}, is coupled to a diode-connected transistor 572 to generate a bias voltage M_{BIAS}. The diode-connected transistor 572 is coupled to the capacitor 560 via the switch 540 and is also coupled to the capacitor 565 via the switch 555. The capacitor 560 is also coupled to the control terminal of a transistor 574, and the capacitor 565 is also coupled to the control terminal of a transistor 576.

The diode-connected transistor 572 is also coupled to a current mirror 578 via a current source 575. The current mirror 574 output and the current source 525 (which supplies the offset current I_{OFFSET2}) are coupled to a current terminal of the transistor 574 via a switch 578 and a cascode transistor 579. The switch 578 is controlled by the control signal CNTRL_{LS}, while the cascode transistor 579 is biased by a voltage V_{NCAS}. The current mirror 578 output and the current source 525 are also coupled to a current terminal of the transistor 576 via a switch 580 and a cascode transistor 581. The switch 580 is controlled by the control signal CNTRL_{LS_Z}. The cascode transistor 581 is also biased by the voltage V_{NCAS}. The node 583 between the current source 525 (and current mirror 578 output) and the switches 578 and 580 is coupled to a buffer 590, which outputs the TRAN_DETECT signal. The current mirror 578 can provide a replica of I_{LOAD_SNS} to one of the transistors 574 or 576, depending on which one of the switches 578 or 580 is enabled.

The load transient detection circuitry 320 of FIG. 5C can operate in a similar way as the load transient detection circuitry 320 of FIGS. 5A and 5B. Specifically, when the CNTRL_{LS} is asserted and the CNTRL_{LS_Z} is de-asserted (e.g., the transistor 210 is conducting), the switch 555 is enabled, and the M_{BIAS} voltage across the diode-connected transistor 572, caused by conduction of I_{LOAD_SNS} when the transistor 210 is conducting, is sampled by the capacitor 565. After the switch 555 is disabled, the capacitor 565 can hold the M_{BIAS} voltage representing the I_{LOAD} when the transistor 210 is conducting. Also, when the CNTRL_{LS_Z} is asserted and the CNTRL_{LS} is de-asserted (e.g., the transistor 210 is not conducting), the switch 540 is enabled, and the M_{BIAS} voltage across the diode-connected transistor 572, caused by conduction of I_{LOAD_SNS} when the transistor 210 is not conducting, is sampled by the capacitor 540. After the switch 540 is disabled, the capacitor 540 can hold the M_{BIAS} voltage.

Also, when the CNTRL_{LS} is asserted, the switch 578 is enabled and the switch 580 is disabled. A current equal to a sum of I_{OFFSET2} and the current I_{LOAD_SNS} is provided to the transistor 574 via the switch 578. The control terminal of the transistor 574 is coupled to the capacitor 560, and the transistor 574 can sink a current representing the prior I_{LOAD_SNS} when the CNTRL_{LS_Z} is asserted. If the sum of I_{OFFSET2} and the current I_{LOAD_SNS} is less than the prior I_{LOAD_SNS} when the CNTRL_{LS_Z} is asserted, the voltage of the node 583 can be pulled down to the ground voltage, which also causes the buffer 584 to switch the state of the TRAN_DETECT signal. Likewise, when the CNTRL_{LS_Z} was last asserted, the switch 580 is enabled and the switch 578 is disabled, and the node 583 can also be pulled down to the ground voltage if the sum of I_{OFFSET2} and the current I_{LOAD_SNS} is less than the prior I_{LOAD_SNS} when the CNTRL_{LS} was last asserted. Accordingly, the state of the TRAN_DETECT signal can represent a comparison between the changes in the current I_{LOAD_SNS} (the load step) between the turning on and off the transistor 210 and a threshold represented by I_{OFFSET2}. The I_{OFFSET2} can be a fixed value or can vary with I_{LOAD_SNS} so that the trip threshold is a function of the load current, as in the example of FIG. 5B.

FIG. 5D is a schematic diagram of another example of the load transient detection circuitry 320. The example shown in FIG. 5D is similar to FIG. 5C, with the addition of circuits 590 and 592. Circuits 590 and 592 can inject antiphase charge into, respectively, the capacitors 560 and 565, which can reduce sampling error due to charge injection by the switches 540 and 555 and improve the accuracy in tracking the load step and mitigating shoot through.

Specifically, the circuit 590 is coupled to the capacitor 560, and circuit 592 is coupled to the capacitor 565. The circuit 590 can include a cascode transistor 591a biased by the voltage V_{NCAS} coupled to a transistor 591b biased by the M_{BIAS} voltage, as well as the drain and source of the transistor 591c, which can be a replica of the switch 540. The circuit 590 also includes a transistor 591d coupled between the cascode transistor 591a and V_{DD}, and a transistor 591e coupled between the cascode transistor 591a and GND, both of which are controlled by the control signal CNTRL_{LS}. When CNTRL_{LS} is de-asserted, a current that tracks the current I_{LOAD_SNS} can flow through the transistors 591d, 591a, and 591b. As CNTRL_{LS} switches from the de-asserted state to the asserted state, charge due to the switching can be injected to the capacitor 560 via the gate-source and gate-drain capacitances of the transistor 591c to compensate for the charge injected by the switch 540 when CNTRL_{LS_Z} switches from the de-asserted state to the asserted state (anti-phase from the switching of CNTRL_{LS}) to enable the capacitor 560 to sample the M_{BIAS} voltage.

FIG. 6 is a schematic diagram of examples of the delay circuitry 325, 330, 335, 340 of FIG. 3. The examples of FIG. 6 include delay circuitry 600, an inverter 605, delay circuitry 610, an inverter 615, and an amplifier 620. The delay circuitry 600 is an example implementation of the delay circuitry 325, 335 of FIG. 3. The delay circuitry 610 is an example implementation of the delay circuitry 330, 340 of FIG. 3.

The delay circuitry 600 receives an inverted PWM control signal (PWM_{CNTRL_Z}) and one of the charge voltage (V_{SW_CHARGE}) or the common mode voltage (V_{SW_CM}). The inverted PWM control signal (PWM_{CNTRL} Z) is the logical inverse of the PWM control signal (PWM_{CNTRL}). The delay circuitry 600 of FIG. 6 includes a current source 624, transistors 628, 632, and a capacitor 636. The transistors 628, 632 sink current from the current source 624 responsive to the inverted PWM control signal (PWM_{CNTRL} Z) and one of the charge voltage (V_{SW_CHARGE}) or the common mode voltage (V_{SW_CM}). For example, the inverted PWM control signal (PWM_{CNTRL_Z}) controls the transistor 628 and the charge voltage (V_{SW_CHARGE}) controls the transistor 632. In some examples, if the inverted PWM control signal (PWM_{CNTRL} Z) is set (e.g., the transistor 210 is on), the transistor 628 sets a voltage (V_{DELAY1}) approximately equal to the common potential. The transistor 628 turns off responsive to a falling edge of the inverted PWM control signal (PWM_{CNTRL} Z). After the transistor 628 turns off, current of the transistor 632 begins to charge the capacitor 636 and set the delay voltage (V_{DELAY1}).

In operation, the capacitor 636 increases the delay voltage (V_{DELAY1}) at a rate that is a function of the capacitance (C), the current (I_{CTAT}) of the current source 624, and a target voltage (V_{target}) at the control terminal of the transistor 632. In some examples, the current (I_{CTAT}) of the current source 624 may be a function of temperature (e.g., having a CTAT relationship), such that the delay circuitry 600 may generate a delay in a manner to compensate the CTAT behavior of the body diode of the LS FET (e.g., transistor 210). In some examples, such as in the delay circuitry 325, the target voltage (V_{target}) is equal to the charge voltage (V_{SW_CHARGE}). In other examples, such as in the delay circuitry 335, the target voltage (V_{target}) is equal to the common mode voltage (V_{SW_CM}). In both examples, a delay (DELAY₁) of the delay circuitry 600 may be found using Equation (1).

$${DELAY}_{1} = \frac{C * {V}_{target}}{{I}_{CTAT}} \qquad Equation ( 1 )$$

The inverter 605 is coupled to the delay circuitry 600, 610. The inverter 605 receives the delay voltage (V_{DELAY1}). The inverter 605 of FIG. 6 includes a transistor 640, a resistor 644, and a transistor 648. The transistors 640, 648 generate an inverted delay signal (DELAY1_Z) by inverting logic levels of the delay voltage (V_{DELAY1}). If the delay voltage (V_{DELAY1}) exceeds a threshold voltage of the transistor 648, the transistor 648 turns on to set the inverted delay signal (DELAY1_Z) to the common potential. Alternatively, if the delay voltage (V_{DELAY1}) is at least a threshold voltage of the transistor 640 less than the supply voltage (VDD), the transistor 640 supplies current to the resistor 644. The resistor 644 pulls the inverted delay signal (DELAY1_Z) towards the supply voltage (VDD) responsive to current from the transistor 640. The inverter 605 provides a logically inverted representation of the delay voltage (V_{DELAY1}) to the delay circuitry 610.

The delay circuitry 610 receives the inverted delay signal (DELAY1_Z) and one of the sensed load current (I_{LOAD_SNS}) or the offset current (I_{OFFSET1}). The delay circuitry 610 of FIG. 6 includes a current source 652, a transistor 656, a current source 660, and transistors 664, 668, 672, 676. The transistor 656 sinks a current (I_{PTAT}) from the current source 652 responsive to the inverted delay signal (DELAY1_Z). In some examples, the current (I_{PTAT}) of the current source 652 may be a function of temperature (e.g., having a PTAT relationship), such that the delay circuitry 610 may generate a delay in a manner to compensate the PTAT behavior of driver turn-on time. The transistor 656 sets the gate voltages of the transistor 664, 668, 672, 676 to the common potential by sinking the current (I_{PTAT}). After a falling edge of the inverted delay signal (DELAY1_Z), the transistor 656 turns off, allowing the current source 652 to charge the control terminals of the transistors 664, 668, 672, 676. The transistors 664, 668, 672, 676 begin to conduct current responsive to the accumulated charge producing a voltage exceeding a threshold voltage.

During the operations between the transistor 656 turning off and the transistors 664, 668, 672, 676 turning on, internal capacitances of the transistors 664, 668, 672, 676 control the rate of charge by the current source 652. For example, a first conducting material of the control terminal (e.g., gate), a non-conducting material of a dielectric (e.g., an oxide) layer, and conducting material(s) of a current terminal (e.g., drain or source) of the transistor 664 form capacitances between the different terminals. Characteristics of the capacitors, such as capacitance, are set by the size of the transistors 664, 668, 672, 676. For example, adjusting a length or width of a channel of any of the transistors 664, 668, 672, 676 adjusts the capacitance formed between the corresponding terminals. In the example of FIG. 6, the transistors 664, 668, 672, 676 are selected to have lengths and widths corresponding to the length and width of the transistor 205. For example, the transistors 664, 668, 672, 676 have channel lengths and widths that are a function of the length and width of the transistor 205. In such examples, the transistors 664, 668, 672, 676 form a capacitance representing the capacitance of the transistor 205. Although in the example of FIG. 6, the transistors 664, 668, 672, 676 are illustrated and described, in other examples, the delay circuitry 610 may include any number of transistors to replicate a capacitance of the transistor 205. Advantageously, sizing the transistors 664, 668, 672, 676 allows the delay circuitry 610 to represent operations of the transistor 205 using relatively smaller transistors.

In operation, the transistors 664, 668, 672, 676 sink current from the current source 660. In some examples, the current source 660 is a discrete component set to provide one of the sensed load current (I_{LOAD_SNS}) or the offset current (I_{OFFSET1}). In other examples, the current source 660 is external component(s) that provide a current that is a function of the sensed load current (I_{LOAD_SNS}) or the offset current (I_{OFFSET1}). The current source 660 and the transistors 664, 668, 672, 676 produce a second delay voltage (V_{DELAY2}). Before a falling edge of the inverted delay signal (DELAY1_Z), the transistor 656 is in the ON state to turn off the transistors 664, 668, 672, 676, and the current source 660 pulls the delay voltage (V_{DELAY2}) towards the supply voltage (V_{DD}) responsive to the transistor 656 turning off the transistors 664, 668, 672, 676. After a falling edge of the inverted delay signal (DELAY1_Z), the transistor 656 turns off, and the transistors 664, 668, 672, 676 begin to conduct current pull the delay voltage (V_{DELAY2}) towards the common potential. However, the capacitances of the transistors 664, 668, 672, 676 delay the decrease in the delay voltage (V_{DELAY2}) by a rate that is a function of the current from the current source 660. In such operations, the transistors 664, 668, 672, 676 replicate the delay in turning on of the transistor 205 responsive to the load current (I_{LOAD}).

The inverter 615 is coupled to the delay circuitry 610. The inverter 615 receives the delay voltage (V_{DELAY2}). The inverter 615 of FIG. 6 includes a transistor 680, a resistor 684, and a transistor 688. The transistors 680, 688 generate one of the high-side turn on signal (HS_{ON}) or the delayed low-side turn off signal (LS_{OFF_DELAY}) by inverting logic levels of the delay voltage (V_{DELAY2}). If the delay voltage (V_{DELAY2}) exceeds a threshold voltage of the transistor 688, the transistor 688 turns on to set the high-side turn on signal (HS_{ON}) or the delayed low-side turn off signal (LS_{OFF_DELAY}) to the common potential. Alternatively, if the delay voltage (V_{DELAY2}) is at least a threshold voltage of the transistor 680 less than the supply voltage (V_{DD}), the transistor 680 supplies current to the resistor 684. The resistor 684 pulls the high-side turn on signal (HS_{ON}) or the delayed low-side turn off signal (LS_{OFF_DELAY}) towards the supply voltage (V_{DD}) responsive to current from the transistor 680. The inverter 615 provides the high-side turn on signal (HS_{ON}) or the delayed low-side turn off signal (LS_{OFF_DELAY}) as a logically inverted representation of the delay voltage (V_{DELAY2}). For example, if the delay circuitry 600 receives the charge voltage (V_{SW_CHARGE}) and the delay circuitry 610 receives the sensed load current (I_{LOAD_SNS}), the inverter 615 provides the low-side turn off signal (LS_{OFF_DELAY}). In another example, if the delay circuitry 600 receives the common mode voltage (V_{SW_CM}) and the delay circuitry 610 receives the offset current (I_{OFFSET1}), the inverter 615 provides the high-side turn on signal (HS_{ON}).

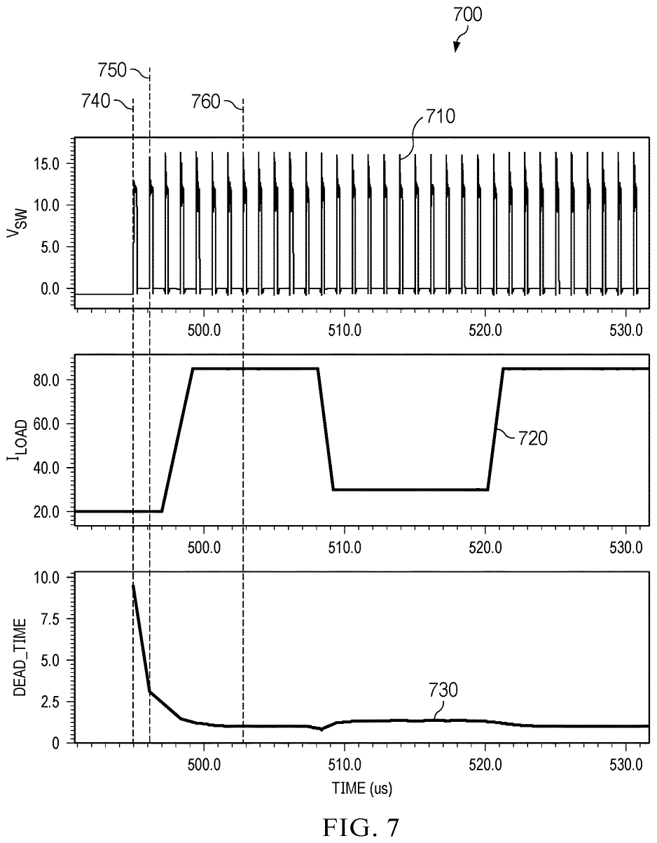

Advantageously, the delay circuitry 600 delays the turn off of the transistor 210 by a first delay that is a function of the node voltage (V_{SW}). Advantageously, the delay circuitry 610 further delays the turn off of the transistor 210 by a second delay that is a function of the load current (I_{LOAD}). Advantageously, the delay circuitry 600, 610 decrease the dead time of the power stage 140 by delaying the turn off of the transistor 210 to account for the delays in turning on the transistor 205 resultant from the node voltage (V_{SW}) and the load current (I_{LOAD}). Advantageously, the delay circuitry 600, 610 can account for temperature variations by using currents that are complementary and a function of absolute temperature (CTAT, PTAT). Example operations of the delay circuitry 600, 610 or, more generally, the ADTR circuitry 160 are further illustrated and described in FIG. 7.

FIG. 7 is a timing diagram 700 of example operations of the ADTR circuitry 160 of FIGS. 1, 2, and 3. The example timing diagram 700 of FIG. 7 illustrates a node voltage 710, a load current 720, and a dead time 730. The node voltage 710 represents the node voltage (V_{SW}) between the transistors 205, 210. The load current 720 represents the load current (I_{LOAD}) through the inductor 215. The dead time 730 represents the dead time between turning off the transistor 210 and turning on the transistor 205.

Prior to time 740, the power converter 120 is in an off or idle state. During such time, the controller 150 sets the node voltage 710 to the common potential, the load current 720 is relatively low, and the dead time 730 is undefined because the transistors 205, 210 are not switching. At the time 740, the power converter 120 enters an on state by turning off the transistor 210 and turning on the transistor 205. At the time 740, the node voltage 710 increases as the transistor 205 conducts current. At the time 740, the load current 720 remains fixed despite a change at the load 130. At the time 740, the dead time 730 is approximately nine nanoseconds.

Prior to time 750, the integrator 310 integrates the node voltage (V_{SW}) to generate the charge voltage (V_{SW_CHARGE}). Between the times 740, 750, the controller 150 switches the transistors 205, 210 to set the node voltage 710. During such time, the delay circuitry 325, 600 delays the turn off of the transistor 210 using the charge voltage (V_{SW_CHARGE}). Similarly, the delay circuitry 330, 610 further delays turning off the transistor 210 using the load current 720. Advantageously, at the time 750, the delays of the delay circuitry 325, 330, 600, 610 decrease the dead time 730 in comparison to the dead time at the time 740.

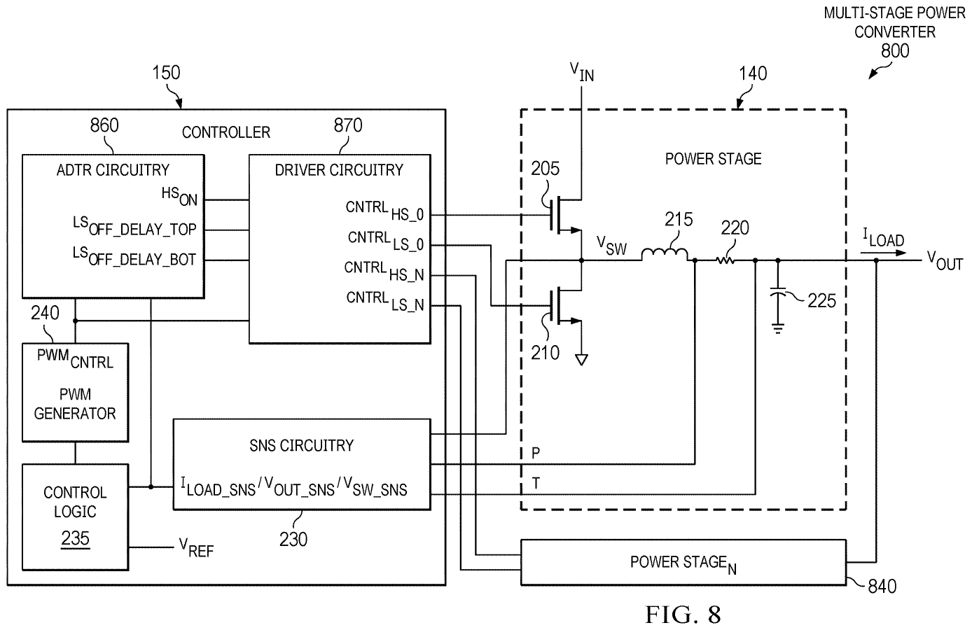

Between times 750, 760, the ADTR circuitry 160 continues to decrease the dead time 730 of the transistors 205, 210 to approximately one nanosecond. Also, between the times 750, 760, the load current 720 experiences transient conditions. However, the delay circuitry 330, 610 account for the changes in the load current 720 by adjusting the turn off of the transistor 210. Advantageously, the ADTR circuitry 160 decreases the dead time 730 between switching of the transistors 205, 210. Advantageously, the ADTR circuitry 160 compensates for transient voltages and currents of the power stage 140. Another example of the ADTR circuitry 160 is further illustrated and described in connection with FIGS. 8, 9, and 10.

FIG. 8 is a schematic diagram of an example power converter 800, which is another example of the power converter 120 of FIG. 1. The example power converter 800 of FIG. 8 includes power stages 140, 840, ADTR circuitry 860, and driver circuitry 870. In the example of FIG. 8, the power converter 800 is a multi-stage power converter. Multi-stage power converters sequence multiple power stages, such as the power stages 140, 840, to increase the load current (I_{LOAD}) without increasing the voltage (V_{OUT}) at the output. Although the power converter 800 includes the power stages 140, 840, in other examples, the power converter 800 may be modified to include any number (N) of power stages.

The power stages 140, 840 are coupled to the controller 150. The power stages 140, 840 provide power to a load (e.g., the load 130) by regulating power from a power supply (e.g., the power supply 110). In the example of FIG. 8, components of the power stage 140 are illustrated for simplicity. In this description, the power stage 840 is another example of the power stage 140. The power stage 840 may have additional connections (not illustrated for simplicity) to the controller 150, for example, to provide sensed signals. Each of the power stages 140, 840 receives a separate set of control signals (CNTRL_{HS}, CNTRL_{LS}) from the controller 150. For example, the power stage 140 receives the control signals (CNTRL_{HS_0}, CNTRL_{LS_0}) and the power stage 840 receives the control signals (CNTRL_{HS_N}, CNTRL_{LS_N}). Both sets of control signals (CNTRL_{HS_0}, CNTRL_{LS_0}, CNTRL_{HS_N}, CNTRL_{LS_N}) operate similar to the control signals (CNTRL_{HS}, CNTRL_{LS}) described in connection with FIG. 2.

The ADTR circuitry 860 is coupled to the sense circuitry 230, the PWM generation circuitry 240, and driver circuitry 870. The ADTR circuitry 860 is an alternative embodiment of the ADTR circuitry 160 of FIGS. 1, 2, and 3 for multi-stage power converters, such as the power converter 800. The ADTR circuitry 860 generates the high-side turn on signal (HS_{ON}), a top delayed low-side turn off signal (LS_{OFF_DELAY_TOP}), and a bottom delayed low-side turn off signal (LS_{OFF_DELAY_BOT}). The top and bottom delayed low-side turn off signals (LS_{OFF_DELAY_TOP}, LS_{OFF_DELAY_BOT}) represent the turn off of the transistor 210 in both of the power stages 140, 840.

The driver circuitry 870 is coupled to the ADTR circuitry 860 and the power stages 140, 840. The driver circuitry 870 receives the high-side turn on signal (HS_{ON}), the top delayed low-side turn off signal (LS_{OFF_DELAY_TOP}), the bottom delayed low-side turn off signal (LS_{OFF_DELAY_BOT}), and the PWM control signal (PWM_{CNTRL}). The driver circuitry 870 controls switching of the power stages 140, 840 responsive to the high-side turn on signal (HS_{ON}), the top delayed low-side turn off signal (LS_{OFF_DELAY_TOP}), and the bottom delayed low-side turn off signal (LS_{OFF_DELAY_BOT}).

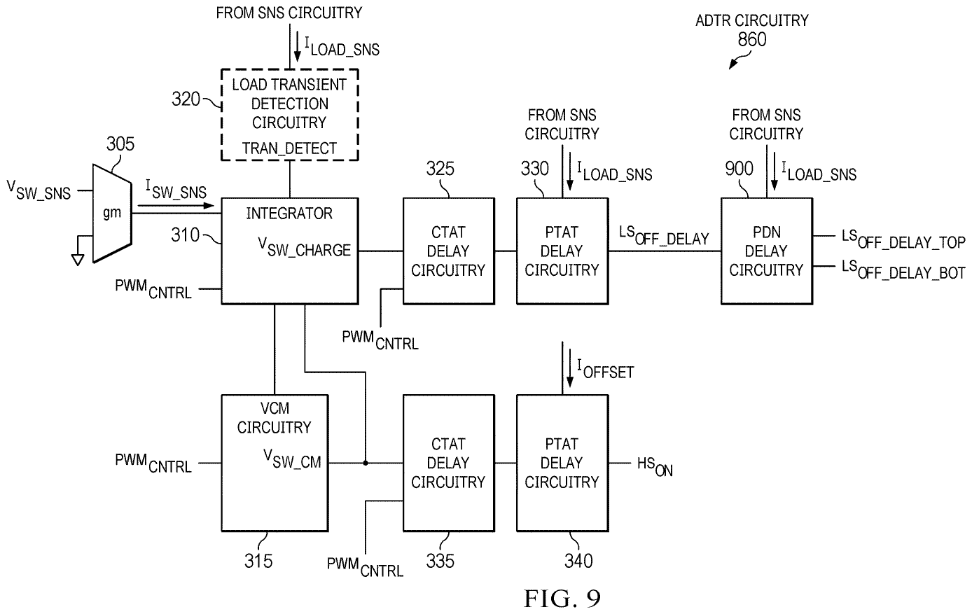

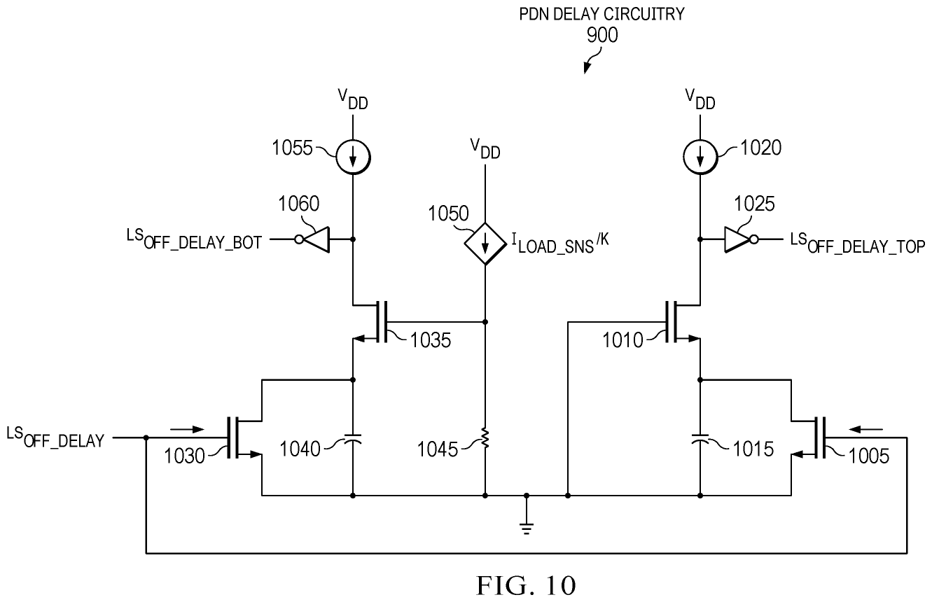

In operation, the delay between the driver circuitry 870 setting either of the top or bottom delayed low-side turn off signals (LS_{OFF_DELAY_TOP}, LS_{OFF_DELAY_BOT}) and the corresponding power stages 140, 840 turning off the transistor 210 is the same. However, in reality, differences in the electrical routes between the controller 150 and the power stages 140, 840 adds an uneven delay between the top and bottom delayed low-side turn off signals (LS_{OFF_DELAY_TOP}, LS_{OFF_DELAY_BOT}). The ADTR circuitry 860 of FIG. 8 includes additional circuitry to account for the differences between electrical paths of the power stages 140, 840. Advantageously, further delaying at least one of the top or bottom delayed low-side turn off signals (LS_{OFF_DELAY_TOP}, LS_{OFF_DELAY_BOT}) allows the ADTR circuitry 860 to account for mismatch in the electrical routing (e.g., electrical trace) of the power stages 140, 840. Examples of the ADTR circuitry 860 are further illustrated and described in connection with FIGS. 9 and 10.

FIG. 9 is a block diagram of an example of the ADTR circuitry 860, which is another example of the ADTR circuitry 160 of FIGS. 1, 2, and 3. In the example of FIG. 8, the ADTR circuitry 860 includes the transconductance amplifier 305, the integrator 310, the common mode voltage circuitry 315, the load transient detection circuitry 320, the delay circuitry 325, 330, 335, 340, and power delivery network (PDN) delay circuitry 900. Unlike the ADTR circuitry 160 of FIGS. 1, 2, and 3, in addition to the high-side turn on signal (HS_{ON}), the ADTR circuitry 860 produces the top and bottom delayed low-side turn off signals (LS_{OFF_DELAY_TOP}, LS_{OFF_DELAY_BOT}). Similar to the delayed low-side turn off signal (LS_{OFF_DELAY}), the top and bottom delayed low-side turn off signals (LS_{OFF_DELAY_TOP}, LS_{OFF_DELAY_BOT}) sequence the turn off of the corresponding ones of the transistor 210 in the power stages 140, 840.

The PDN delay circuitry 900 is coupled to the delay circuitry 330. The PDN delay circuitry 900 receives the delayed low-side turn off signal (LS_{OFF_DELAY}). The PDN delay circuitry 900 generates a first one of top or bottom delayed low-side turn off signals (LS_{OFF_DELAY_TOP}, LS_{OFF_DELAY_BOT}) using timing similar to edges of the delayed low-side turn off signal (LS_{OFF_DELAY}). The PDN delay circuitry 900 generates a second one of the top or bottom delayed low-side turn off signals (LS_{OFF_DELAY_TOP}, LS_{OFF_DELAY_BOT}) using a time constant to delay edges of the delayed low-side turn off signal (LS_{OFF_DELAY}).

In some examples, the time constant of the PDN delay circuitry 900 is to account for a delay between the power stages 140, 840 and the controller 150. For example, a first electrical trace between the power stage 140 and the controller 150 has a first length and a second electrical trace between the controller 150 and the power stage 840 has a second length that is greater than the first length. Physical restraints in placement of the power stages 140, 840 produce the different lengths. In such examples, parasitic inductance and capacitance of the paths cause signals traversing the second electrical path to take longer to reach a destination in comparison to signals of the first path. The PDN delay circuitry 900 accounts for the delay in the electrical traces by delaying signal with the shorter signal path by a time constant that is a function of the delay of the longer trace. An example of the PDN delay circuitry 900 is further illustrated and described in connection with FIG. 10.

FIG. 10 is a schematic diagram of an example of the PDN delay circuitry 900. In the example of FIG. 10, the PDN delay circuitry 900 includes transistors 1005, 1010, a capacitor 1015, a current source 1020, an inverter 1025, transistors 1030, 1035, a capacitor 1040, a resistor 1045, current sources 1050, 1055, and an inverter 1060. The PDN delay circuitry 900 receives the delayed low-side turn off signal (LS_{OFF_DELAY}) and the sensed load current (I_{LOAD_SNS}). The PDN delay circuitry 900 generates the top and bottom delayed low-side turn off signals (LS_{OFF_DELAY_TOP}, LS_{OFF_DELAY} BOT) to account for delays in a power delivery network of multiple power stages.

In the example of FIG. 10, the top delayed low-side turn off signal (LS_{OFF_DELAY_TOP}) corresponds to a power stage having an electrical trace with a larger inductance. In operation, the transistors 1005, 1010, the capacitor 1015, the current source 1020, and the inverter 1025 generate the top delayed low-side turn off signal (LS_{OFF_DELAY_TOP}) using the delayed low-side turn off signal (LS_{OFF_DELAY}). Specifically, when the delayed low-side turn off signal (LS_{OFF_DELAY}) is deasserted (e.g., at a low level), the transistor 1005 allows the transistor 1010 to charge the capacitor 1015 with current from the current source 1020. Shortly after beginning to charge the capacitor 1015, the capacitor 1015 sets the source voltage of the transistor 1010 to turn off the transistor 1010. In the example of FIG. 10, the transistor 1010 is a natural transistor that conducts current when the gate-to-source voltage is approximately zero. After the capacitor 1015 turns off the transistor 1010, the current source 1020 pulls an input of the inverter 1025 towards the supply voltage (V_{DD}). The inverter 1025 deasserts the top delayed low-side turn off signal (LS_{OFF_DELAY_TOP}) responsive to the current source 1020 setting the input to a high level.

In such operations to generate the top delayed low-side turn off signal (LS_{OFF_DELAY_TOP}), the transistor 1005 shorts the capacitor 1015 responsive to a rising edge of the delayed low-side turn off signal (LS_{OFF_DELAY}). If the capacitor 1015 is shorted, the transistor 1010 begins to conduct current. When conducting, the transistors 1005, 1010 pull the input of the inverter 1025 towards the common potential. The inverter 1025 sets the top delayed low-side turn off signal (LS_{OFF_DELAY_TOP}) responsive to the transistors 1005, 1010 conducting current.

In the example of FIG. 10, the bottom delayed low-side turn off signal (LS_{OFF_DELAY_BOT}) corresponds to a power stage having an electrical trace with a smaller inductance in comparison to the power stage of the top delayed low-side turn off signal (LS_{OFF_DELAY_TOP}). In operation, the transistors 1030, 1035, the capacitor 1040, the resistor 1045, the current sources 1050, 1055, and the inverter generate the bottom delayed low-side turn off signal (LS_{OFF_DELAY_BOT}) using the delayed low-side turn off signal (LS_{OFF_DELAY}).

Specifically, when the delayed low-side turn off signal (LS_{OFF_DELAY}) is deasserted, the transistor 1030 is off, which allows the transistor 1035 to charge the capacitor 1040 with current from the current source 1055. Simultaneously, the current source 1050 is setting the gate voltage of the transistor 1035 using the sensed load current (I_{LOAD_SNS}) and the resistor 1045. In some examples, the current source 1050 supplies a current that is a function of the load current (I_{LOAD}), the sensed load current (I_{LOAD_SNS}), or a scaled load current (I_{LOAD_SNS}/K). Unlike the transistor 1010 and the capacitor 1015, the transistor 1035 takes additional time to turn off. Such additional time is a result of the transistor 1035 having to charge the capacitor 1040 to approximately the voltage set by the current source 1050 and the resistor 1045. In such examples, the transistor 1035 is a natural transistor having a threshold voltage approximately equal to zero volts. Once the capacitor 1040 sets the source terminal of the transistor 1035 to approximately the gate voltage, the transistor 1035 turns off, allowing the current source 1055 to pull the input of the inverter 1060 towards the supply voltage (V_{DD}). The inverter 1060 deasserts the bottom delayed low-side turn off signal (LS_{OFF_DELAY_BOT}) responsive to the current source 1055 setting the input.

In such operations to generate the bottom delayed low-side turn off signal (LS_{OFF_DELAY_BOT}), the transistor 1030 discharges the capacitor 1040 responsive to a rising edge of the delayed low-side turn off signal (LS_{OFF_DELAY}). The transistor 1030 discharges the capacitor 1040 at a rate set by a time constant between the capacitor 1040 and resistances of the transistors 1030, 1035 and the current source 1055. After the transistor 1030 begins discharging the capacitor 1040, the transistor 1035 begins conducting current. When conducting, the transistors 1030, 1035 pull the input of the inverter 1060 towards the common potential. The inverter 1060 sets the bottom delayed low-side turn off signal (LS_{OFF_DELAY_BOT}) responsive to the transistors 1030 discharging the capacitor 1040 to a voltage less than a threshold. Advantageously, charging and discharging the capacitor 1040 delays edges of the delayed low-side turn off signal (LS_{OFF_DELAY}) to account for propagation delays of electrical traces in a multi-stage power converter, such as the power converter 800.

In the example of FIGS. 2, 6, and 10, the transistors 205, 210, 628, 632, 648, 656, 664, 668, 672, 676, 688, 1005, 1010, 1030, 1035 are n-channel metal-oxide semiconductor field-effect transistors (MOSFETs). Alternatively, the transistors 205, 210, 628, 632, 648, 656, 664, 668, 672, 676, 688, 1005, 1010, 1030, 1035 may be n-channel field-effect transistors (FETs), n-channel insulated-gate bipolar transistors (IGBTs), n-channel junction field effect transistors (JFETs), NPN bipolar junction transistors (BJTs) or, with slight modifications, p-type equivalent devices. In the example of FIGS. 5 and 6, the transistors 510, 535, 640, 680 are p-channel MOSFETs. Alternatively, the transistors 510, 535, 640, 680 may be p-channel FETs, p-channel IGBTs, p-channel JFETs, PNP BJTs, or, with slight modifications, N-type equivalent devices. The transistors 205, 210, 510, 535, 628, 632, 640, 648, 656, 664, 668, 672, 676, 680, 688, 1005, 1010, 1030, 1035 may be depletion mode devices, drain-extended devices, enhancement mode devices, natural transistors or other type of device structure transistors. Furthermore, the transistors 205, 210, 510, 535, 628, 632, 640, 648, 656, 664, 668, 672, 676, 680, 688, 1005, 1010, 1030, 1035 may be implemented in/over a silicon substrate (Si), a silicon carbide substrate (SiC), a gallium nitride substrate (GaN) or a gallium arsenide substrate (GaAs).

Following are additional examples provided in view of the above-described implementations. Here, one or more features of example, in isolation or in combination, can be combined with one or more features of one or more other examples to form further examples also falling within the scope of the disclosure. As such, one implementation can be combined with one or more other implementation without changing the scope of disclosure.

Example 1: An apparatus comprising: an integrator having an output; first delay circuitry having an input and an output, the input of the first delay circuitry coupled to the output of the integrator; and second delay circuitry coupled to the first delay circuitry, the second delay circuitry including: a first current source having a terminal; a first transistor having a current terminal and a control terminal, the control terminal of the first transistor coupled to the output of the first delay circuitry; a second transistor having a first current terminal, a second current terminal, and a control terminal; a second current source having a terminal coupled to the first current terminal of the second transistor; and a third transistor having a current terminal and a control terminal, the current terminal of the third transistor coupled to the second current terminal of the second transistor, the control terminal of the third transistor coupled to the current terminal of the first transistor, the terminal of the first current source, and the control terminal of the second transistor.

Example 2. The apparatus of example 1, further comprising: a first inverter having an input and an output, the input of the first inverter coupled to the output of the first delay circuitry, the output of the first inverter coupled to the control terminal of the first transistor; and a second inverter having an input and an output, the input of the second inverter coupled to the current terminal of the second transistor and the terminal of the second current source.

Example 3: The apparatus of any one of examples 1-2, wherein the first delay circuitry includes: a fourth transistor having a current terminal; a third current source having a terminal; a fifth transistor having a first current terminal, a second current terminal, and a control terminal, the first current terminal of the fifth transistor coupled to the control terminal of the first transistor, the current terminal of the fourth transistor, and the terminal of the third current source, the control terminal of the fifth transistor coupled to the output of the integrator; and a capacitor having a terminal coupled to the second current terminal of the fifth transistor.

Example 4: The apparatus of any one of examples 1-3, wherein the current terminal of the third transistor is a first current terminal, the third transistor further has a second current terminal, and the second delay circuitry further includes: a fourth transistor having a first current terminal, a second current terminal, and a control terminal, the first current terminal of the fourth transistor coupled to the second current terminal of the third transistor; and a fifth transistor having a current terminal and a control terminal, the current terminal of the fifth transistor coupled to the second current terminal of the fourth transistor, the control terminal of the fifth transistor coupled to the current terminal of the first transistor, the terminal of the first current source, the control terminal of the second transistor, the control terminal of the third transistor, and the control terminal of the fourth transistor.

Example 5: The apparatus of any one of claims 1-4, wherein the integrator further has an input, and the apparatus further comprises: a voltage source having a terminal; third delay circuitry having an input and an output, the input of the third delay circuitry coupled to the input of the integrator and the terminal of the voltage source; and fourth delay circuitry having an input coupled to the output of the third delay circuitry.

Example 6: The apparatus of example 5, wherein the fourth delay circuitry further has an output, the apparatus further comprising: a sixth transistor having a current terminal and a control terminal; a seventh transistor having a current terminal and a control terminal, the current terminal of the seventh transistor coupled to the current terminal of the sixth transistor; and driver circuitry having a first input, a second input, a first output, and a second output, the first input of the driver circuitry coupled to the first current terminal of the second transistor and the terminal of the second current source, the second input of the driver circuitry coupled to the output of the fourth delay circuitry, the first output of the driver circuitry coupled to the control terminal of the sixth transistor, the second output of the driver circuitry coupled to the control terminal of the seventh transistor.

Example 7: The apparatus of any one of examples 5-6, wherein the fourth delay circuitry further has an output, the apparatus is further comprising: a first power stage having a first input and a second input; a second power stage having a first input and a second input, the first input of the second power stage coupled to the output of the fourth delay circuitry and the first input of the first power stage; and power delivery network (PDN) delay circuitry having an input, a first output, and a second output, the input of the PDN delay circuitry coupled to the first current terminal of the second transistor and the terminal of the second current source, the first output of the PDN delay circuitry coupled to the second input of the first power stage, the second output of the PDN delay circuitry coupled to the second input of the second power stage.

Example 8: The apparatus of any one of examples 1-7, wherein the integrator further has an input, the apparatus further comprising: a transconductance amplifier having an input and an output, the output of the transconductance amplifier coupled to the input of the integrator; a fourth transistor having a current terminal; a fifth transistor having a current terminal; and an inductor having a terminal coupled to the input of the transconductance amplifier, the current terminal of the fourth transistor, and the current terminal of the fifth transistor.

Example 9: The apparatus of example 8, wherein the second current source further has a control terminal, the terminal of the inductor is a first terminal, the inductor further having a second terminal, and the apparatus further comprising: a resistor having a first terminal and a second terminal; and sense circuitry having a first input, a second input, and an output, the first input of the sense circuitry coupled to the second terminal of the inductor and the first terminal of the resistor, the second input of the sense circuitry coupled to the second terminal of the resistor, the output of the sense circuitry coupled to the control terminal of the second current source.

Example 10: The apparatus of any one of examples 8-9, wherein the integrator further has an input, the fifth transistor further has a control terminal, and the apparatus further comprises load transient detection circuitry having a first input, a second input, and an output, the first input of the load transient detection circuitry coupled to the second current source, the second input of the load transient detection circuitry coupled to the control terminal of the fifth transistor, and the output of the load transient detection circuitry coupled to the input of the integrator.

Example 11: The apparatus of example 10, wherein the load transient detection circuit is configurable to reset the integrator responsive to a transient in a load current exceeding a threshold.

Example 12: The apparatus of example 11, wherein the threshold is configurable based on the load current.

Example 13: The apparatus of any one of examples 11 or 12, wherein the load transient detection circuit includes a first capacitor and a second capacitor, the first capacitor configurable to sample and hold a first voltage representing the load current when the fifth transistor is turned on, the second capacitor configurable to store a second voltage representing the load current when the fifth transistor is turned on, and the load transient detection circuit is configurable to reset the integrator responsive to: a first difference between the first voltage and a third voltage representing the load current when the fifth transistor is turned off exceeding the threshold; or a second difference between the second voltage and a fourth voltage representing the load current when the fifth transistor is turned on exceeding the threshold.

Example 14: The apparatus of example 13, wherein the load transient detection circuit includes antiphase charge injection circuits coupled to the first and second capacitors.

Example 15: The apparatus of any one of examples 1-14, wherein the input of the first delay circuitry is a first input, the first delay circuitry further having a second input, and the apparatus further comprising: sense circuitry having an output; control logic having an input and an output, the input of the control logic coupled to the output of the sense circuitry; pulse width modulation (PWM) generation circuitry having an input and an output, the input of the PWM generation circuitry coupled to the output of the control logic, the output of the PWM generation circuitry coupled to the second input of the first delay circuitry; and driver circuitry having an input coupled to the first current terminal of the second transistor and the terminal of the second current source.

Example 16: An apparatus comprising: pulse width modulation (PWM) generation circuitry configurable to generate a PWM signal, the PWM signal having a duty cycle; first delay circuitry configurable to delay an edge of the PWM signal responsive to a voltage signal; and second delay circuitry coupled to the first delay circuitry, the second delay circuitry configurable to further delay the edge of the PWM signal responsive to a current signal.

Example 17: The apparatus of example 16, wherein the PWM signal is a first PWM signal, the apparatus further comprising: third delay circuitry configurable to delay an edge of a second PWM signal as a function of a propagation delay of the first delay circuitry, the second PWM signal having the duty cycle of the first PWM signal; and fourth delay circuitry configurable to further delay the edge of the second PWM signal as a function of a propagation delay of the second delay circuitry.

Example 18: The apparatus of any one of examples 16 or 17, wherein the first delay circuitry is configurable to delay the edge of the PWM signal according to a complementary to absolute temperature (CTAT) relationship.

Example 19: The apparatus of any one of examples 16-18, wherein the second delay circuitry is configurable to delay the edge of the PWM signal according to a proportional to absolute temperature (PTAT) relationship.

Example 20: The apparatus of any one of examples 16-19, further comprising: driver circuitry coupled to the second delay circuitry, the driver circuitry configurable to generate a first signal and a second signal based on the PWM signal with the delayed edge; and a power stage coupled to the driver circuitry, the power stage configurable to supply power to a load responsive to the first and second signals, wherein the voltage signal is associated with an output voltage of the power stage and the current signal is associated with an output current of the power stage, wherein the PWM generation circuitry is configurable to generate the PWM signal based on the output voltage of the power stage.

Example 21: The apparatus of example 20, wherein the power stage includes: a first transistor coupled to the driver circuitry, the first transistor configurable to switch responsive to the first signal; and a second transistor coupled to the driver circuitry and the first transistor, the second transistor configurable to switch responsive to the second signal.

Example 22: The apparatus of any one of examples 20-21, further comprising: a load transient detection circuit configurable to detect load transients based on the current signal; a transconductance amplifier configurable to generate an output current based on the output voltage of the power stage; and an integrator configurable to generate the voltage signal based on at least one of the output current, the load transients, or the PWM signal.

Example 23: An apparatus comprising a power stage including a first transistor having a current terminal and a control terminal; and a second transistor having a control terminal, and a current terminal coupled to the current terminal of the first transistor. The apparatus also comprises driver circuitry having an input, a first output, and a second output, the first output of the driver circuitry coupled to the control terminal of the first transistor, the second output of the driver circuitry coupled to the control terminal of the second transistor. The apparatus also comprises control circuitry coupled to the driver circuitry and configurable to adjust a dead time of the power stage responsive to a transient in a current conducted by the power stage exceeding a threshold.

Example 24: The apparatus of example 23, wherein the control circuit is configurable to determine a transient responsive to a difference between the current when the second transistor is turned on and when the second transistor is turned off.

Example 25: The apparatus of example 24, wherein the control circuit is configurable to adjust the threshold responsive to a magnitude of the current.

Example 26: The apparatus of any one of examples 23-25, wherein the power stage, the driver circuitry, and the control circuitry is part of a multi-phase power converter, and the apparatus further comprises a processor coupled to a power output of the multi-phase power converter.

Example 27: The apparatus of example 26, wherein the processor includes at least one of a central processing unit (CPU) or a graphical processing unit (GPU).

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and things, the phrase “at least one of A and B” refers to implementations including any of (1) at least one A, (2) at least one B, or (3) at least one A and at least one B. Similarly, as used herein in the context of describing structures, components, items, objects and things, the phrase “at least one of A or B” refers to implementations including any of (1) at least one A, (2) at least one B, or (3) at least one A and at least one B. As used herein in the context of describing the performance or execution of processes, instructions, actions, activities, etc., the phrase “at least one of A and B” refers to implementations including any of (1) at least one A, (2) at least one B, or (3) at least one A and at least one B. Similarly, as used herein in the context of describing the performance or execution of processes, instructions, actions, activities, etc., the phrase “at least one of A or B” refers to implementations including any of (1) at least one A, (2) at least one B, or (3) at least one A and at least one B.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements, or actions may be implemented by, e.g., the same entity or object. Also, although individual features may be included in different examples or claims, these may possibly be combined, and the inclusion in different examples or claims does not imply that a combination of features is at least one of not feasible or advantageous.

As used herein, connection references (e.g., attached, coupled, connected, and joined) may include intermediate members between the elements referenced by at least one of the connection reference or relative movement between those elements unless otherwise indicated. As such, connection references do not necessarily infer that two elements are directly connected or in fixed relation to each other. As used herein, stating that any part is in “contact” with another part is defined to mean that there is no intermediate part between the two parts.

Unless specifically stated otherwise, descriptors such as “first,” “second,” “third,” “fourth,” “fifth,” “sixth,” “seventh,” etc., are used herein without imputing or otherwise indicating any meaning of priority, physical order, arrangement in a list, or ordering in any way, but are merely used as at least one of labels or arbitrary names to distinguish elements for ease of understanding the described examples. In some examples, the descriptor “first” may be used to refer to an element in the detailed description, while the same element may be referred to in a claim with a different descriptor such as “second” or “third.” In such instances, such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to at least one of manufacturing tolerances or other real-world imperfections. For example, “approximately” and “about” may indicate such dimensions may be within a tolerance range of +/−10% unless otherwise specified herein.

As used herein, integrated circuit/circuitry may be understood as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

A device that is “configured to” or “configurable to” perform a task or function may be configured (e.g., at least one of programmed or hardwired) at a time of manufacturing by a manufacturer to at least one of perform the function or be configurable (or re-configurable) by a user after manufacturing to perform the function/or other additional or alternative functions. The configuring may be through at least one of firmware or software programming of the device, through at least one of a construction or layout of hardware components and interconnections of the device, or a combination thereof.

As used herein, the terms “terminal,” “node,” “interconnection,” “pin” and “lead” are used interchangeably. Unless specifically stated to the contrary, these terms are generally used to mean an interconnection between or a terminus of a device element, a circuit element, an integrated circuit, a device, or other electronics or semiconductor component.

In the description and claims, described “circuitry” may include one or more circuits. A circuit or device that is described herein as including certain components may instead be adapted to be coupled to those components to form the described circuitry or device. For example, a structure described as including one or more semiconductor elements (such as transistors), one or more passive elements (such as one of or a combination of resistors, capacitors, or inductors), or one or more sources (such as voltage and/or current sources) may instead include only the semiconductor elements within a single physical device (e.g., at least one of a semiconductor die or integrated circuit (IC) package) and may be adapted to be coupled to at least some of the passive elements or the sources to form the described structure either at a time of manufacture or after a time of manufacture, for example, by at least one of an end-user or a third-party.

Circuits described herein are reconfigurable to include the replaced components to provide functionality at least partially similar to functionality available prior to the component replacement. Components shown as resistors, unless otherwise stated, are generally representative of any one or more elements coupled in at least one of series or parallel to provide an amount of impedance represented by the shown resistor. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor. While certain elements of the described examples are included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and some features illustrated as being internal to the integrated circuit may be incorporated outside of the integrated. As used herein, the term “integrated circuit” means one or more circuits that are at least one of: (i) incorporated in/over a semiconductor substrate; (ii) incorporated in a single semiconductor package; (iii) incorporated into the same module; or (iv) incorporated in/on the same printed circuit board.

Modifications are possible in the described embodiments, and other embodiments are possible, within the scope of the claims.

What is claimed is:

1. An apparatus comprising:
an integrator having an output;
first delay circuitry having an input and an output, the input of the first delay circuitry coupled to the output of the integrator; and
second delay circuitry coupled to the first delay circuitry, the second delay circuitry including:
a first current source having a terminal;
a first transistor having a current terminal and a control terminal, the control terminal of the first transistor coupled to the output of the first delay circuitry;
a second transistor having a first current terminal, a second current terminal, and a control terminal;
a second current source having a terminal coupled to the first current terminal of the second transistor; and
a third transistor having a current terminal and a control terminal, the current terminal of the third transistor coupled to the second current terminal of the second transistor, the control terminal of the third transistor coupled to the current terminal of the first transistor, the terminal of the first current source, and the control terminal of the second transistor.

2. The apparatus of claim 1, further comprising:
a first inverter having an input and an output, the input of the first inverter coupled to the output of the first delay circuitry, the output of the first inverter coupled to the control terminal of the first transistor; and
a second inverter having an input and an output, the input of the second inverter coupled to the current terminal of the second transistor and the terminal of the second current source.

3. The apparatus of claim 1, wherein the first delay circuitry includes:
a fourth transistor having a current terminal;
a third current source having a terminal;
a fifth transistor having a first current terminal, a second current terminal, and a control terminal, the first current terminal of the fifth transistor coupled to the control terminal of the first transistor, the current terminal of the fourth transistor, and the terminal of the third current source, the control terminal of the fifth transistor coupled to the output of the integrator; and
a capacitor having a terminal coupled to the second current terminal of the fifth transistor.

4. The apparatus of claim 1, wherein the current terminal of the third transistor is a first current terminal, the third transistor further has a second current terminal, and the second delay circuitry further includes:
a fourth transistor having a first current terminal, a second current terminal, and a control terminal, the first current terminal of the fourth transistor coupled to the second current terminal of the third transistor; and
a fifth transistor having a current terminal and a control terminal, the current terminal of the fifth transistor coupled to the second current terminal of the fourth transistor, the control terminal of the fifth transistor coupled to the current terminal of the first transistor, the terminal of the first current source, the control terminal of the second transistor, the control terminal of the third transistor, and the control terminal of the fourth transistor.

5. The apparatus of claim 1, wherein the integrator further has an input, and the apparatus further comprises:
a voltage source having a terminal;
third delay circuitry having an input and an output, the input of the third delay circuitry coupled to the input of the integrator and the terminal of the voltage source; and
fourth delay circuitry having an input coupled to the output of the third delay circuitry.

6. The apparatus of claim 5, wherein the fourth delay circuitry further has an output, the apparatus further comprising:
a sixth transistor having a current terminal and a control terminal;
a seventh transistor having a current terminal and a control terminal, the current terminal of the seventh transistor coupled to the current terminal of the sixth transistor; and
driver circuitry having a first input, a second input, a first output, and a second output, the first input of the driver circuitry coupled to the first current terminal of the second transistor and the terminal of the second current source, the second input of the driver circuitry coupled to the output of the fourth delay circuitry, the first output of the driver circuitry coupled to the control terminal of the sixth transistor, the second output of the driver circuitry coupled to the control terminal of the seventh transistor.

7. The apparatus of claim 5, wherein the fourth delay circuitry further has an output, the apparatus is further comprising:
a first power stage having a first input and a second input;
a second power stage having a first input and a second input, the first input of the second power stage coupled to the output of the fourth delay circuitry and the first input of the first power stage; and
power delivery network (PDN) delay circuitry having an input, a first output, and a second output, the input of the PDN delay circuitry coupled to the first current terminal of the second transistor and the terminal of the second current source, the first output of the PDN delay circuitry coupled to the second input of the first power stage, the second output of the PDN delay circuitry coupled to the second input of the second power stage.

8. The apparatus of claim 1, wherein the integrator further has an input, the apparatus further comprising:
a transconductance amplifier having an input and an output, the output of the transconductance amplifier coupled to the input of the integrator;
a fourth transistor having a current terminal;
a fifth transistor having a current terminal; and
an inductor having a terminal coupled to the input of the transconductance amplifier, the current terminal of the fourth transistor, and the current terminal of the fifth transistor.

9. The apparatus of claim 8, wherein the second current source further has a control terminal, the terminal of the inductor is a first terminal, the inductor further having a second terminal, and the apparatus further comprising:
a resistor having a first terminal and a second terminal; and
sense circuitry having a first input, a second input, and an output, the first input of the sense circuitry coupled to the second terminal of the inductor and the first terminal of the resistor, the second input of the sense circuitry coupled to the second terminal of the resistor, the output of the sense circuitry coupled to the control terminal of the second current source.

10. The apparatus of claim 8, wherein the integrator further has an input, the fifth transistor further has a control terminal, and the apparatus further comprises load transient detection circuitry having a first input, a second input, and an output, the first input of the load transient detection circuitry coupled to the second current source, the second input of the load transient detection circuitry coupled to the control terminal of the fifth transistor, and the output of the load transient detection circuitry coupled to the input of the integrator.

11. The apparatus of claim 10, wherein the load transient detection circuit configurable to reset the integrator responsive to a transient in a load current exceeding a threshold.

12. The apparatus of claim 11, wherein the threshold is configurable based on the load current.

13. The apparatus of claim 11, wherein the load transient detection circuit includes a first capacitor and a second capacitor, the first capacitor configurable to sample and hold a first voltage representing the load current when the fifth transistor is turned on, the second capacitor configurable to store a second voltage representing the load current when the fifth transistor is turned on, and the load transient detection circuit is configurable to reset the integrator responsive to:
a first difference between the first voltage and a third voltage representing the load current when the fifth transistor is turned off exceeding the threshold; or
a second difference between the second voltage and a fourth voltage representing the load current when the fifth transistor is turned on exceeding the threshold.

14. The apparatus of claim 13, wherein the load transient detection circuit includes antiphase charge injection circuits coupled to the first and second capacitors.

15. The apparatus of claim 1, wherein the input of the first delay circuitry is a first input, the first delay circuitry further having a second input, and the apparatus further comprising:
sense circuitry having an output;
control logic having an input and an output, the input of the control logic coupled to the output of the sense circuitry;
pulse width modulation (PWM) generation circuitry having an input and an output, the input of the PWM generation circuitry coupled to the output of the control logic, the output of the PWM generation circuitry coupled to the second input of the first delay circuitry; and
driver circuitry having an input coupled to the first current terminal of the second transistor and the terminal of the second current source.

16. An apparatus comprising:
pulse width modulation (PWM) generation circuitry configurable to generate a PWM signal, the PWM signal having a duty cycle;
first delay circuitry configurable to delay an edge of the PWM signal responsive to a voltage signal; and
second delay circuitry coupled to the first delay circuitry, the second delay circuitry configurable to further delay the edge of the PWM signal responsive to a current signal.

17. The apparatus of claim 16, wherein the PWM signal is a first PWM signal, the apparatus further comprising:
third delay circuitry configurable to delay an edge of a second PWM signal as a function of a propagation delay of the first delay circuitry, the second PWM signal having the duty cycle of the first PWM signal; and
fourth delay circuitry configurable to further delay the edge of the second PWM signal as a function of a propagation delay of the second delay circuitry.

18. The apparatus of claim 16, wherein the first delay circuitry is configurable to delay the edge of the PWM signal according to a complementary to absolute temperature (CTAT) relationship.

19. The apparatus of claim 16, wherein the second delay circuitry is configurable to delay the edge of the PWM signal according to a proportional to absolute temperature (PTAT) relationship.

20. The apparatus of claim 16, further comprising:
driver circuitry coupled to the second delay circuitry, the driver circuitry configurable to generate a first signal and a second signal based on the PWM signal with the delayed edge; and
a power stage coupled to the driver circuitry, the power stage configurable to supply power to a load responsive to the first and second signals, wherein the voltage signal is associated with an output voltage of the power stage and the current signal is associated with an output current of the power stage,
wherein the PWM generation circuitry is configurable to generate the PWM signal based on the output voltage of the power stage.

21. The apparatus of claim 20, wherein the power stage includes:
a first transistor coupled to the driver circuitry, the first transistor configurable to switch responsive to the first signal; and
a second transistor coupled to the driver circuitry and the first transistor, the second transistor configurable to switch responsive to the second signal.

22. The apparatus of claim 20, further comprising:
a load transient detection circuit configurable to detect load transients based on the current signal;
a transconductance amplifier configurable to generate an output current based on the output voltage of the power stage; and
an integrator configurable to generate the voltage signal based on at least one of the output current, the load transients, or the PWM signal.

23. An apparatus comprising:
a power stage including:
a first transistor having a current terminal and a control terminal; and
a second transistor having a control terminal, and a current terminal coupled to the current terminal of the first transistor;
driver circuitry having an input, a first output, and a second output, the first output of the driver circuitry coupled to the control terminal of the first transistor, the second output of the driver circuitry coupled to the control terminal of the second transistor;
control circuitry coupled to the driver circuitry and configurable to adjust a dead time of the power stage responsive to a transient in a current conducted by the power stage exceeding a threshold.

24. The apparatus of claim 23, wherein the control circuit is configurable to determine a transient responsive to a difference between the current when the second transistor is turned on and when the second transistor is turned off.

25. The apparatus or claim 24, wherein the control circuit is configurable to adjust the threshold responsive to a magnitude of the current.

26. The apparatus of claim 23, wherein the power stage, the driver circuitry, and the control circuitry is part of a multi-phase power converter, and the apparatus further comprises a processor coupled to a power output of the multi-phase power converter.

27. The apparatus of claim 26, wherein the processor includes at least one of a central processing unit (CPU) or a graphical processing unit (GPU).
